(19) United States
(12) Patent Application Publication
(10) Pub. No.: US 2025/0322607 A1
(43) Pub. Date: Oct. 16, 2025

(54) MESH BASED DISCRETE GLOBAL GRID SYSTEM AND METHODS FOR CONSTRUCTION

(71) Applicant: BigGeo Inc., Calgary (CA)

(72) Inventors: Lakin WECKER, Calgary (CA); John HALL, Calgary (CA); Faramarz Famil SAMAVATI, Calgary (CA)

(21) Appl. No.: 19/175,069

(22) Filed: Apr. 10, 2025

Related U.S. Application Data
(60) Provisional application No. 63/633,303, filed on Apr. 12, 2024.

(51) Int. Cl. G06T 17/05; G06T 5/80; G06T 17/20

(52) U.S. Cl. CPC G06T 17/05; G06T 5/80; G06T 17/205; G06T 2207/30181; G06T 2210/36

(57) ABSTRACT

A Mesh-Based Discrete Global Grid System (MBD), which generalizes efficient operations over watertight triangular meshes with spherical topology is described. This allows for high-resolution polyhedra to be used as the base polyhedron for the MBD while maintaining efficient operations. Several new polyhedra with lower area and angular distortion are described and experimentally validated to demonstrate their efficiency.

### FIELD

A Mesh-Based Discrete Global Grid System (MBD), which generalizes efficient operations over watertight triangular meshes with spherical topology is described. This allows for high-resolution polyhedra to be used as the base polyhedron for the MBD while maintaining efficient operations. Several new polyhedra with lower area and angular distortion are described and experimentally validated to demonstrate their efficiency.

### BACKGROUND

In the modern era, immense amounts of location-aware data is being collected. As a result, there is a demand for digital models of the Earth (e.g. Digital Earth) which can warehouse, process and visualize this high-volume, high-resolution data in an efficient and undistorted manner. However, the global scale, high-volume, high-resolution and high-variance nature of this data makes this challenging.

As is known, flat maps have been used as the computational and visual model of a Digital Earth (DE). Traditional flat maps have numerous disadvantages in the digital age for many reasons including utilizing a single projected image of the Earth. That is, the projected image has breaks on the boundaries and significant non-uniform distortion which limits its suitability for global-scale modelling and visualizations.

As an alternative, continuous curved models of the Earth can be used, however, digital computers are better suited to efficiently handle discrete representations. Discrete Global Grid Systems (DGGS) aim to address the challenges of boundaries and distortion. Importantly DGGS can provide an efficient computational model by using a discrete representation of the Earth, which is well suited to modern computing paradigms. Such systems can address the variance in data resolution by providing a hierarchy of grids at multiple resolutions and enable operations to traverse the hierarchy.

DGGS can address global scale by ensuring the grids cover the entire Earth with mostly uniform discrete elements (cells) and provide operations to traverse spatial neighborhoods. In addition, DGGS can provide unique identifier (indices) for every cell at every resolution which allows for data to be efficiently warehoused and queried.

However, efficiently modelling and operating directly on the Earth's true shape is challenging.

For example, most DGGS are based on a polyhedral approximation (base polyhedron) of the Earth. The base polyhedron provides an efficient domain in which to perform many of the core DGGS operations. However, the base polyhedron requires a mapping (projection) between the surface of the Earth and its polyhedral faces. The projection introduces distortion and computational cost.

State of the art DGGS can be broadly categorized into two groups, a) those which aim to preserve area (low-distortion DGGS) [1], [2], but have inefficient operations as a result, and b) those which aim for efficiency first (efficiency-first DGGS) but may have inconsistent area or angle distortion [3], [4].

There is a need for DGGS that have low-distortion whilst also having geometric edges and efficient operations.

### SUMMARY

In accordance with the disclosure, there is provided a method of generating a high-resolution spherical geometry model comprising the steps of: from an initial polyhedra having multiple planar base faces: a) refine the initial polyhedra to form a refined base polyhedra wherein each planar base face is refined to include a plurality of child faces having child face vertices; and b) map the child face vertices from step a) to a sphere to form a spherical high-resolution base-polyhedron model characterized as highly-uniform wherein all child faces are the same shape and size.

In various embodiments:
the planar base faces are any one of a triangle, quad, pentagon or hexagon.
the base faces are triangles.
the child faces have low-angular distortion.
angular distortion is less than 0.09, and more preferably is less than 0.01.
step a) includes refining each planar base face to n child faces having child face vertices.
each planar base face is a triangle and step a) includes refining each base face to n² child faces having child face vertices.
the method includes the step of repeating step a) one or more times prior to step b).
step b) is a uniformity-preserving projection and includes mapping vertices of the refined base polyhedra to a sphere and connecting vertices with geodesic edges.
the high-resolution base polyhedra has geodesic edges.
the geodesic edges are great circle arcs in spherical space and straight lines in polyhedral space.
the high-resolution initial polyhedra is any one of an octahedron, icosahedron, pentakis dodecahedron or disdyakis triacontrahedron.
step b) is a uniformity preserving projection configured to map the child face vertices from step a) to a sphere.
the uniformity preserving projection is an equal area projection work.
the uniformity preserving projection is a slice-and-dice equal area projection.
the refined polyhedron has a maximum area/minimum area ratio less than 1.9.
the refined polyhedron has a maximum area/minimum area ratio less than 1.5 and preferably less than 1.25.

In another aspect, a method of creating a lookup structure on a base polyhedron model is described, the base polyhedron model having a plurality of planar faces having planar face edges and face vertexes to produce a lookup structure, comprising the steps of: a) defining a grid having a plurality of grid elements where the grid defines an array of buckets; b) overlaying the grid from step a) on the base polyhedron model wherein each bucket is overlaid on the planar faces such that each bucket: i) is fully contained within a planar face; ii) overlaps a planar face edge; iii) overlaps a face vertex; or iv) fully contains a planar face; to produce an encoded lookup structure having lookup cells.

In various embodiments:
the planar faces are any one of a triangle, quad, pentagon or hexagon.
the planar faces are triangles.
the grid elements are defined by a grid having a minimum grid edge length and a number of rows and columns in the lookup structure.
each row of the grid is defined in latitude coordinates and each column of the grid is defined in longitude coordinates.
the method further includes the steps of determining if a bucket is contained within a planar face, or intersects a planar face and, if yes, associating a bucket with a planar face.
the method further includes the step of determining if a bucket contains a planar face.
step a) includes calculating a minimum planar face edge length.

In another aspect, a method of encoding a geospatial point to a lookup structure having a plurality of buckets overlaid on a base polyhedron model is described, the method comprising the steps of:
i. for a given geospatial point having point coordinates:
   1. determining which bucket of the lookup structure the geospatial point is associated with;
   2. determining if the bucket has only one face;
      a. if yes, computing a cell index for the geospatial point;
      b. if no, applying a rule to determine which face within the bucket contains the geospatial point, and, thereafter assigning a cell index for the geospatial point.

In various embodiments:
step i) for a given geospatial point having point coordinates includes converting the point coordinates to R³ and S² geometry coordinates.
in step (2)(b), R³ geometry coordinates are utilized to determine which face within the bucket contains the geospatial point.

In another aspect, an efficient low-distortion system for processing geospatial data is described comprising: a spherical high-resolution base-polyhedron model (HRBP) characterized as highly-uniform wherein all children are planar faces having a uniform shape and size; the HRBP having an encoded look-up structure, having a bucket wherein each bucket is overlaid on the planar faces such that each bucket: i) is fully contained within a planar face; ii) overlaps a planar face edge; iii) overlaps a planar vertex; or iv) fully contains a planar face; and, one or more geospatial points encoded to the lookup structure wherein each point is associated with a single planar face of a bucket.

In various embodiments,
the planar faces are any one of a triangle, quad, pentagon or hexagon.
the planar faces are triangles.
the encoded look-up structure has grid elements overlaid on the HRBP defining an array of buckets.
the system further includes an indexing system.
the indexing system is a barycentric index and wherein the barycentric index is derived from a barycentric index method including step of, for a given cell based on a given geospatial point, projecting the geospatial point to the face.
the system further includes a neighbor cell index, wherein the neighbor cell index is derived from a neighbor cell index method including the step of determining an orientation of a cell as aligned or not-aligned with a base face.
the system further includes a parent cell index, wherein the parent cell index is derived from a parent cell index method.
the system further includes a child cell index, wherein the child cell index is derived from a child cell index method.
the system further includes a spherical geometry for a given cell.

### BRIEF DESCRIPTION OF THE DRAWINGS

Various objects, features and advantages of the disclosure will be apparent from the following description of particular embodiments, as illustrated in the accompanying drawings. The drawings are not necessarily to scale, emphasis instead being placed upon illustrating the principles of various embodiments of the disclosure. Similar reference numerals indicate similar components.

FIG. 1 illustrates different DGGS approaches with different polyhedra being mapped to a sphere and the tradeoff between low angular distortion (d_{θ}), low areal distortion (d_{A}), geodesic edges (GE) and efficient operations (EO). (A) shows how a low-resolution polyhedron with an equal area mapping eliminate areal distortion (Low d_{A}), but still includes angular distortion (d_{θ}), having non-geodesic edges (GE) and inefficient operations (EO), (B) shows a DGGS with a low-resolution polyhedron which uses efficient projection, it has distorted areas, distorted angles, but has efficient operations and geodesic edges; and (C) shows a high-level MBD having low angular and areal distortion (Low d_{A}/d_{θ}) and having geodesic edges and efficient operations.

FIG. 2 shows a comparison of how an area within 5,000 km of Calgary is mapped on a flat map and various 3D models. A flat map (a) shows severe distortion whereas each of traditional low resolution polyhedra such as a icosahedron (b), and disdyakis triacontahedron (c) also show distortion. Mesh based DGGS (d) provides efficient operation for any watertight, triangular base polyhedron such as the refined pentakis dodecahedron with 960 faces. A sphere (e) shows that the area with the distance maps as a circle.

FIG. 3 are images showing a typical process for geocoding a coarse boundary of Greenland within an octahedral DGGS. (a) a coarse outline of Greenland. (b) the base cell that contains it. (c) the boundary after projection to the face of an octahedron (d) the cells which contain the boundary (e) encoding the boundary within the cells (f) inverse projecting back to the geospatial domain.

FIG. 4 are images showing that by increasing the resolution of the base polyhedron, distortion can be reduced. The decrease in distortion from the (a) octahedron to the (b) icosahedron is evident. However, this decrease continues to the (c) disdyakis triacontahedron and also through the (d) pentakis dodecahedron and the (e) a spherical mesh with 240 faces.

FIG. 5 are images showing that in the case of an octahedron (a), where each cell is completely contained within an octant, it can be determined which cell contains a point by determining which octant the point is within. In the case of an arbitrary mesh (b), the mesh vertices and edges may not be aligned to the latitude/longitude grid, and thus a more general data structure and algorithm must be used.

FIG. 6 are images showing lookup grid-buckets are quads and base polyhedron triangle edges are black lines. Smaller buckets result in fewer cells per bucket.

FIG. 7 are images showing barycentric rows within a base-cell at resolution 2 for v_{A}, v_{B}, and v_{C} respectively.

FIG. 8 are images showing indices for internal cells at resolution (a) 1 and (b) 2. (c) Triangle pairs with duplicate indices if directly using two-dimensional barycentric indexing. 1 bit of information is necessary to disambiguate between the triangles.

FIG. 9 are images showing when converting descendant indices to a neighboring coordinate system, the index for one axis will remain the same, and the index for the other two axes must be swapped. In the top row, c remains the same, and a and b are swapped. In the middle row, a remains the same, and b and c are swapped, and finally, in the last row, b remains the same and c and a are swapped. 9(b)) shows if the edges are numbered and summed, the edge number for each of the cells modulo 3, then the same value for each edge combination that needs the same swap is obtained.

FIG. 10 is an image showing that when cell neighbors cross the edge of a base cell, one of the values in the triplet is unchanged, and two values will swap places. In this figure, the c value stays the same and the a and b swap places.

FIG. 11 are image examples of a spherical subdivision pipeline with the following steps. Step (a): is start with an octahedron. Refine it once and then map the vertices to the sphere using gnomonic projection which is denoted: ORM_{g}. Step (b) is refine an octahedron twice and then map the vertices to the sphere using gnomonic projection which is denoted: OR²M_{g}.

FIG. 12 are images showing the impact of the gnomonic projection on the resulting face size of a refined icosahedron. White denotes the ideal area, grey denotes faces that are larger or smaller than the ideal area. The system can use any mapping for the mesh's vertices, ideally mapping the vertices in a way that increases the area uniformity compared to the gnomonic projection.

FIG. 13 are images showing P_{b} generated from refining P and mapping to the sphere with Mₛ. (e)-(h) shows P_{b} generated from refining D and mapping to the sphere with Mₛ. White is the ideal area, shades of grey are larger or smaller than the ideal area.

FIG. 14 are graphs showing performance of a PointToCell operation for a refined pentakis dodecahedron with conversion from WGS84.

FIG. 15 are graphs showing performance of a PointToCell operation for a refined pentakis dodecahedron without conversion from WGS84.

FIG. 16 are graphs showing performance of a Children operation for a refined pentakis dodecahedron.

FIG. 17 are graphs showing performance of a Parent operation for a refined pentakis dodecahedron.

FIG. 18 are graphs showing performance of a Neighbor operation for a refined pentakis dodecahedron.

FIG. 19 are graphs showing performance of a SphericalGeometryFromIndex operation for a refined pentakis dodecahedron.

FIG. 20 is a flowchart showing a process for preparing a high-resolution base polyhedron (HRBP) that may be used for DGGS.

FIG. 21 is a flowchart showing a process for building a lookup structure on the HRBP.

FIG. 22 is a flowchart showing processes for efficient point encoding using an efficient hash encoding lookup structure.

FIG. 23 is a flowchart showing processes for building an efficient low-distortion system for processing geospatial data.

FIG. 24 is a flowchart showing an iterative process to calculate the index for a given cell based on a given point and the base cell that contains the given point.

FIGS. 25 and 25A are flowcharts showing processes for neighbor (FIG. 25) and neighbor across boundary (FIG. 25A) calculations as input to the efficient mesh-based DGGS process (FIG. 23).

FIGS. 26 and 26A are flowcharts showing processes for parent and child calculations as input to an efficient mesh-based DGGS process (FIG. 23).

FIG. 27 is a flowchart showing a process to calculate the spherical geometry from a given cell.

### DESCRIPTION

### 1. Overview

In this disclosure, low-distortion, high-performance discrete global grid systems (DGGS) which are referred to herein generally as “Mesh-Based DGGS” or “MBD” or “the subject system”) and methods of construction are described that achieve similar distortion reduction as low-distortion DGGS referenced above while maintaining similar performance characteristics as an efficiency-first DGGS referenced above, thereby achieving the best of both approaches.

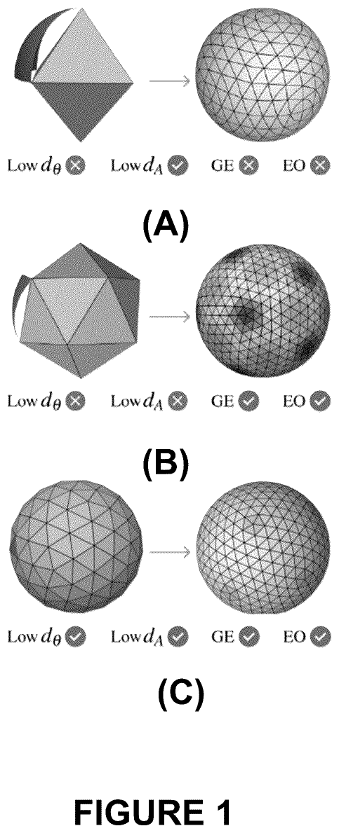

By way of further background and introduction, FIG. 1 illustrates different DGGS approaches with different polyhedra being mapped to a sphere and the trade-off between low angular distortion (d_{θ}), low areal distortion (d_{A}), geodesic edges (GE) and efficient operations (EO). (A) shows how a low-resolution polyhedron with an equal area mapping eliminate areal distortion (Low d_{A}), but still includes angular distortion (d_{θ}), having non-geodesic edges (GE) and inefficient operations (EO), (B) shows a DGGS with a low-resolution polyhedron which uses efficient projection, it has distorted areas, distorted angles, but has efficient operations and geodesic edges; and (C) shows a high-level MBD having low angular and areal distortion (Low d_{A}/d_{θ}) and having geodesic edges and efficient operations.

That is, efficiency-first DGGS use low-resolution polyhedra to allow for efficient operations and then typically pair this polyhedron with a simple projection (e.g., gnomonic) that could have area and angle distortion. For example, at high resolutions, the difference in size between the cells with the minimum area and the cells with the maximum area is nearly two times for [4] and over two times for [3]. Additionally, the angle distortion of both of these DGGS is a function of the number of faces, which results in extreme angle distortion in [3] and reduced but still extreme angle distortion in [4]. Conversely, low-distortion DGGS tend to focus only on a areal-distortion through area preserving projections. However, this ignores angular distortion, which may be increased due to the projection. Additionally, the area-preserving projection necessarily distorts geodesics into non-geodesic curves on the polyhedron and vice-versa.

Area-preserving projections are often used to reduce areal distortion (Alderson et al. 2019) but they necessarily distort the edges of the DGGS cells into non-geodesics (FIG. 1 (A)). These non-geodesic edges complicate geometry algorithms which must either choose to introduce error (for example: by approximating them with a geodesic) or introduce inefficiencies (for example: sampling them heavily or repeating projections between planar and curved domains).

Additionally, area-preserving projections tend to have inefficient implementation (Harrison, Mahdavi-Amiri, and Samavati 2011, 2012) which further impacts the efficiency of the DGGS.

Ideally, employing a high-resolution base polyhedron allows the DGGS to better approximate the Earth, which reduces distortion. The faces of a high-resolution polyhedron better approximate the curved portion of the sphere that they represent, which reduces distortion from projection.

The distortion of the MBD is reduced by using high-resolution polyhedra. This enables the use of an efficient geometric projection which preserves geodesics and has a simple, efficient implementation. However, high-resolution polyhedron can introduce challenges when implementing efficient versions of core DGGS operations.

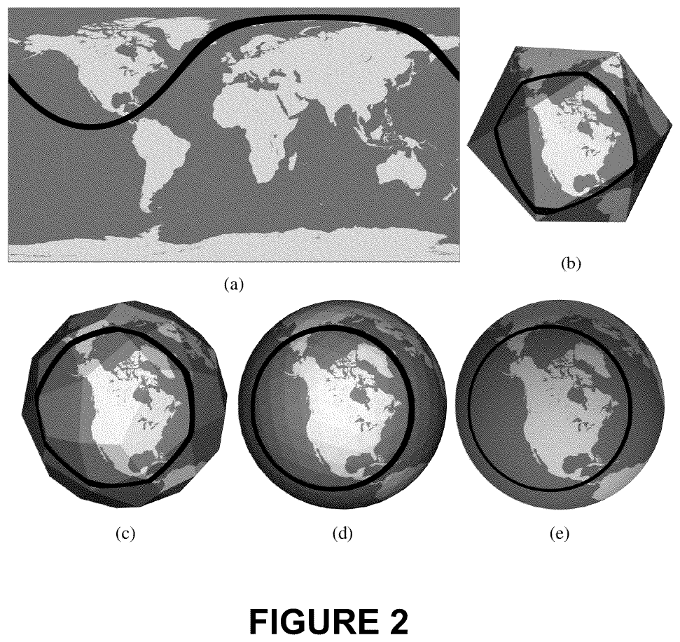

Further, by way of background and introduction, FIG. 2 shows a comparison of how an area within 5,000 km of Calgary is mapped on a flat map and various 3D models. A flat map (a) shows severe distortion whereas each of traditional low resolution polyhedra such as a icosahedron (b), and disdyakis triacontahedron (c) also show distortion. Mesh based DGGS (d) provides efficient operation for any watertight, triangular base polyhedron such as the refined pentakis dodecahedron with 960 faces. A sphere (e) shows that the area with the distance maps as a circle.

In general, the disclosure describes:
a. An efficient hash encoding structure to achieve fast geospatial point encoding.
b. Efficient generalized DGGS operations for watertight triangle meshes with spherical topology.
c. Several new polyhedra which exhibit less angular and area distortion compared to other methods.
d. Experimental validation for base polyhedral.

Referring again to FIG. 1, employing a high-resolution base polyhedron allows the DGGS to better approximate the Earth, which reduces distortion. The faces of a high-resolution polyhedron can better approximate the curved portion of the sphere they represent, reducing distortion from projection.

Area-preserving projections are often used to reduce areal distortion [2], but they necessarily distort the edges of the DGGS cells into non-geodesics (FIG. 1 (A)). These non-geodesic edges complicate commonly used geometric algorithms, which must either choose to introduce error (for example, by approximating them with a geodesic) or introduce inefficiencies (for example, sampling them heavily or repeating projections between planar and curved domains). Additionally, area-preserving projections tend to have inefficient implementation [5, 6], which further impacts the efficiency of the DGGS. In contrast, the subject systems reduce the distortion of a DGGS by using high-resolution base polyhedra. This allows the use a geometric projection which preserves lines and has a simple, efficient implementation. Generally, using these high-resolution base polyhedra introduces other challenges for obtaining efficient core operations in DGGS.

The subject systems address these challenges by describing a method for constructing a DGGS using an arbitrary spherical triangular mesh as the base polyhedron. By using triangle cells, the systems can use and adapt efficient algorithms and data structures from computer graphics to achieve efficient core operations.

In addition, a multiresolution hash encoding method is described. Using a carefully-designed hash function to narrow down candidate cells is highly efficient and optimized, resulting in fast point-to-cell encoding. For efficient representation of cells at all resolutions, the systems adopt a barycentric indexing method (BIM) [10]. Barycentric coordinates provide a fast and natural coordinate system for working with triangular meshes. Additionally, the resulting indices have a simple and efficient implementation of hierarchical and spatial traversal operations, provided these operations remain within a single base cell.

To address spatial traversal across the boundaries of a base cell, the systems adapt Atlas of Connectivity Maps (ACM) [11] to use our BIM. This allows for a set of constant-time operations that have been experimentally verified to be highly efficient.

Another challenge in using a general spherical polyhedron as the base polyhedron in a DGGS is the need to access the geometry and connectivity of the DGGS at all levels of resolution. MBD does not require a system to explicitly store the geometry and connectivity of the DGGS except for the geometry and connectivity of the base polyhedron.

To make the core DGGS operations efficient, the system pre-calculates face normals and edge vectors for each base cell. Using only this information as input, these operations can achieve performance levels similar to the existing performance-first DGGS.

Further, the systems described are generalized across an arbitrary input, watertight triangle mesh with spherical topology, allowing any new mesh to be used as the base polyhedron for an efficient DGGS.

As shown below (see Section 5), several alternative base polyhedra for constructing new DGGS that achieve the same speed as S2 [3] while simultaneously achieving less areal and angular distortion. For example, PR³Mₛ, one of the new base polyhedra, can result in the same performance of S2 for point-to-base-cell operations but with much better area distortion characteristics where the ratio between the max and minimum area of cells at a given resolution is 1.11 in PR³Mₛ vs 2.11 for S2.

Briefly, the disclosure is organized as follows:
Section 1 provides an overview.
Section 2 describes related work.
Section 3 describes how to construct an MBD.
Section 4 describes experimental validation of various MBD's efficiency and distortion characteristics.
Section 5 describes results and performance.
Section 6 provides a summary.

### 2. Related Work

Historically, using grids as a spatial data structure to organize and query data about the earth has a long and varied history [12-18]. At the time, the most promising DGGS were based on using Platonic solids for their initial tessellation, and Sahr denoted these as Geodesic DGGS [18].

In the quarter century since, a considerable number of DGGS have been defined Despite this considerable research, no single DGGS is ideal for all use cases.

The following discusses and reviews the individual components: target spatial domain, proxy domain, desired cell shape, initial tessellation, projection method, refinement method, and indexing method.

### 2.1. Target Spatial Domain

Three spatial domains are commonly used in DGGS literature: the plane, the sphere, and the WGS84 ellipsoid. The plane is the most efficient but has extreme distortion and discontinuous breaks [1]. The sphere is the second most efficient and has significantly less distortion than the plane [10]. The WGS84 ellipsoid is the most accurate approximation of the shape of Earth, but ellipsoidal operations are significantly more expensive. Most DGGS (see tables 22 and 23) use the sphere with only a few using the ellipsoid [22,23] or plane [23]. MBD uses the sphere as its spatial domain to reduce distortion while maintaining efficient operations.

### 2.2. Proxy Domain

DGGS can be constructed directly in the spatial domain or use a proxy domain (such as a polyhedron) for efficient operations. DGGS constructed directly in WGS84 coordinate space have longitude and latitude lines as cell boundaries [23, 24]. Quadtrees are a typical example and are often used for mapping software [25-27]. These DGGS have a simple implementation, can match their resolution to common satellite sensor sizes [23], and have visualization familiarity and efficiency, but the cells at a given resolution vary widely in shape and size, making them less suitable for many operations.

For example, quad-trees tend to use a web-mercator projection, which cannot represent data at the poles, and data near the poles has extreme distortion [1]. Additionally, many geospatial researchers want equal area cells [28, 29], which results in trade-offs, such as degenerate grids (one cell edge borders more than one other cell) or non-uniform cell shapes and sizes [24,30,31]. DGGS constructed directly in spherical or ellipsoidal space [32,33] require non-linear recursive refinement and are much less efficient at high resolutions, especially when equal-area cells are desired, as it requires splitting edges [34] or using small circle arcs produced through non-linear iterative optimizations [35]. DGGS are most commonly constructed using a polyhedral proxy, which allows for efficient planar refinement and indexing but requires a mapping between the proxy and spatial domain, which introduces distortion [36]. The disclosure describes how to create Polyhedral DGGS with low distortion, increased uniformity, and efficient operations.

### 2.3. Cell Shape

DGGS use triangles, quadrilaterals, and hexagons as their cell shapes. Triangles are always planar, have efficient indexing, have efficient, congruent refinement, and are compatible with efficient rendering software and hardware [37]. However, they exhibit poor sampling properties, are the least compact, and do not have uniform adjacency [2]. Quad cells are congruent; directly compatible with the pixels on computer displays and with image-based data sets; have the simplest and most intuitive indexing methods; and have simple, easy-to-understand, low-aperture refinements [2]. Hexagon cells have the best sampling performance [38] with the smallest quantization error and have uniform adjacency [2]. However, hexagons do not have a congruent refinement, do not have direct hardware support for rendering or processing, and have inefficient hierarchical relationships. To achieve a high-performance, low-distortion DGGS, MBD uses triangles as its cell shape.

### 2.4. Base-Polyhedron

The base polyhedron impacts the cell shapes, the total distortion, and the efficiency of operations. The cube and hexahedron have been used to construct a DGGS [22, 39, 40]. They have quadrilateral faces, efficient row-column-based indexing, and a low aperture refinement [40]. However, the cube is a poor approximation of the sphere and has significant distortion (see FIG. 1). The octahedron is one of the most common base polyhedron [12, 16, 33, 41-43]. It can be used directly with triangle cells or as a truncated octahedron, which allows for mostly hexagonal cells (six of them will be quadrilateral at all resolution levels). Due to its symmetries, it has highly efficient point-to-cell operations, but it is also a poor approximation of the sphere and has a large amount of distortion (see FIG. 1). The icosahedron is the most commonly used base polyhedron [15,17,18,32,41,44-47]. It can be used directly with triangle cells or as a truncated icosahedron with mostly hexagonal cells (twelve will be pentagons at all resolution levels). Although both are a better approximation of the sphere than the octahedron and cube, there is still a significant amount of distortion present, and most icosahedral DGGS take steps to reduce distortion by using an area-preserving projection [10](see FIG. 1). There are a handful of other polyhedra used in the literature such as the stellated dodecahedron [34], the rhombic dodecahedron [48], the rhombic triacontahedron [49], and the disdyakis triacontahedron [29].

Of these polyhedra, the disdyakis triacontahedron most closely approximates the sphere, which results in the least distortion [29]. However, the distortion is still high enough that it is paired with an area-preserving projection, which introduces an expensive projection and increases angular and edge distortion. As described herein, changing the base polyhedron requires redefining and designing other components of the DGGS [22,29,40,48]. As a result, previous DGGS are limited to a single polyhedron and are only available for the Platonic, Archimedean, and Catalan solids. MBD enables using any triangle mesh, including high-resolution meshes, which can reduce the distortion to very low levels. Additionally, MBD allows for using a broader range of polyhedra without the need to re-develop other components of the DGGS.

### 2.5. Refinement

Refinement is categorized by the following properties:
a. Cell Shape: Refinements have both an input and output cell shape. Usually, both are the same shape.
b. Aperture: The aperture, n, of a refinement describes the rate of change of the area between resolutions

$$( \frac{1}{n} ) .$$

Lower aperture results in a more gradual progression of cell sizes between levels of resolution, which provides a closer match for the locational uncertainty present in geospatial data [40].
c. Congruency: A refinement is congruent if a parent cell is equal to the partition (as in set-partition) of its children cells. Cells in congruent refinements have exactly one parent, which simplifies hierarchical algorithms.
d. Alignment: The orientation of the children's cells compared to their parents and whether one of them shares its midpoint with the parent cell. Lack of midpoint alignment may result in more quantization errors of data when higher-resolution cells are used.

The planar properties of a refinement method can be used as the justification for refinement choice, but the projection will impact the shape, size, and location of the cells in the spatial domain, which may negatively impact the refinement properties when used in a DGGS.

Hexagons do not have congruent refinement [2] but do have center-aligned refinements, and hexagons have beneficial sampling properties and low quantization error [50], which makes them a popular choice [51, 52]. 1:2 quad refinement is not center aligned but more gradually decreases in cell size and is used in [40]; 1:4 quad refinement is also not centre-aligned and more quickly reduces cell sizes but is popular [22,39,48]; 1:9 quad refinement is center-aligned but is not popular due to its rapidly decreasing cell sizes. Triangles also have many different congruent refinements [2]; their 1:2 refinement is not centre-aligned and is not used; their 1:4 mid-point triangle refinement is congruent and centre-aligned and is a popular choice [16, 33, 53]. Two steps of 1:2 refinement are uncommon but are used to preserve relative compactness [29]. To achieve efficient refinement with triangles, MBD uses 1:4 mid-point refinement.

### 2.6. Indexing

Indexing methods assign a unique identifier to every DGGS cell across all resolution levels. Indices are used for efficient spatial and hierarchy traversal operations; for efficient data access within a database; and for efficient visualizations of geospatial data. There are three types of indexing methods. First, hierarchical indexing schemes prefix a child-cell identifier with its parent cell-identifier [2]. They support efficient hierarchical operations and range queries but may have less efficient point-to-cell and spatial traversal operations. Hierarchical indices are a common choice (see tables 22, 23). Second, space-filling curves visit every element in a domain in a particular order, and the order is used as the index [2]. These indexing methods ensure neighboring cells are neighbors in index space, providing efficient locality-preserving access to data within a spatial neighbourhood [54]. Space-filling curves usually have an efficient and direct conversion to axes-based indexing methods, which makes them popular (see tables 22, 23). Third, coordinate-based indexing methods are similar to 2D array coordinates and take discrete steps along coordinate directions, allowing for an efficient row and column-like indexing, simplifying neighbor calculations [2]. As previously mentioned, there is usually an efficient conversion method between axes-based and space-filling curves. MBD uses a barycentric coordinate-based indexing method, which provides the basis for efficient triangular operations.

### 2.7. Projection

When polyhedral grids are used, projection methods are necessary to map from the spatial domain into the polyhedral grid and vice-versa. Researchers have often sought to reduce the distortion caused by the projection through the use of area-preserving maps [55-60]. Snyder's Equal Area (ISEA) projection is an extension of Fisher's area preserving map for the icosahedron [55] to truncated icosahedron [56]. However, the projection requires an iterative root-finding inverse, which makes it inefficient [5, 6]. Despite its inefficiency, it is popular [51,52,61]. Roşca and Plonka describe a closed form, area-preserving projection scheme for the cube [59] and octahedron [60] which is used in [40]. Van Leeuwen and Strebe propose the closed-form slice-and-dice family of projection methods with area-preservation [58] and less angular distortion when compared to ISEA. Hall et al. [29] extended this method to the disdyakis triacontahedron (DT) and provided a closed-form, efficient inverse and showed that DT has nearly 3.7 times less mean angular distortion across a face when compared to ISEA.

The subject system supports all projection schemes; thus, if an equal-area DGGS is required, MBD may be used with an equal-area polyhedron with an area-preserving projection. However, one of the benefits of the subject system is the reduction of distortion through the use of a high-resolution initial polyhedron, which allows for the use of simpler, more efficient projection methods while still maintaining low overall distortion.

2.8. Related Work from Computer Graphics

MBD utilizes computer graphics' (CG) approaches to efficient spatial lookup structures. For example, in [62], spatial hashing is used to store the vertices of a candidate set of potentially intersecting objects. MBD uses a similar approach to look up a candidate set of cells that may contain a point. However, MBD does not use an axis-aligned bounding box approach due to the nature of the coordinate space on the earth's surface and the resulting distortion. More recently, multiresolution hash encoding has been used to accelerate training high-dimensional parameter vectors for neural graphics primitives [8]. Lower-dimensional input vectors are hashed, and a higher-dimensional parameter vector is generated by linearly interpolating the values found in the multiresolution lookup grid. Furthermore, this method effectively represents large volumetric data sets, enabling interactive visualization in [9]. MBD also uses a geospatial hash-encoding mechanism to turn a lower-dimensional input vector into a higher-dimensional parameter vector that is used to efficiently calculate which base cell contains an input point. However, unlike [8], the subject system does not linearly blend the resulting parameters; instead using them directly. Atlas of Connectivity Maps (ACM) [11] provides an efficient data structure for storing, representing, and traversing meshes at various levels of resolution. As with most mesh-based representations, the entirety of the mesh (or the entirety of a patch of the mesh) is stored in memory for the duration of its processing. In contrast, MBD uses the same ideas to define an efficient set of hierarchical and spatial traversal methods but does not require an explicit representation of the refined geometry to operate at any resolution.

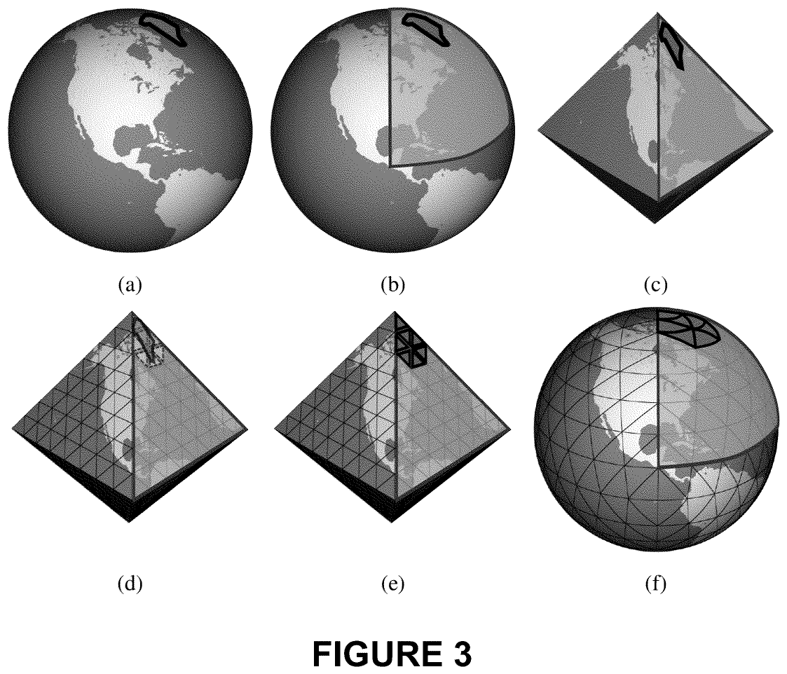

FIG. 3 shows a typical process for geocoding a coarse boundary of a body of land, in this case Greenland, within an octahedral DGGS. 3(a) shows a coarse outline of Greenland. 3(b) shows the base cell that contains Greenland. 3(c) shows the boundary after projection to the face of an octahedron. 3(d) shows the cells which contain the boundary. 3(e) shows encoding the boundary within the cells and 3(f) shows inverse projecting back to the geospatial domain.

### 3. Constructing a Mesh-Based DGGS

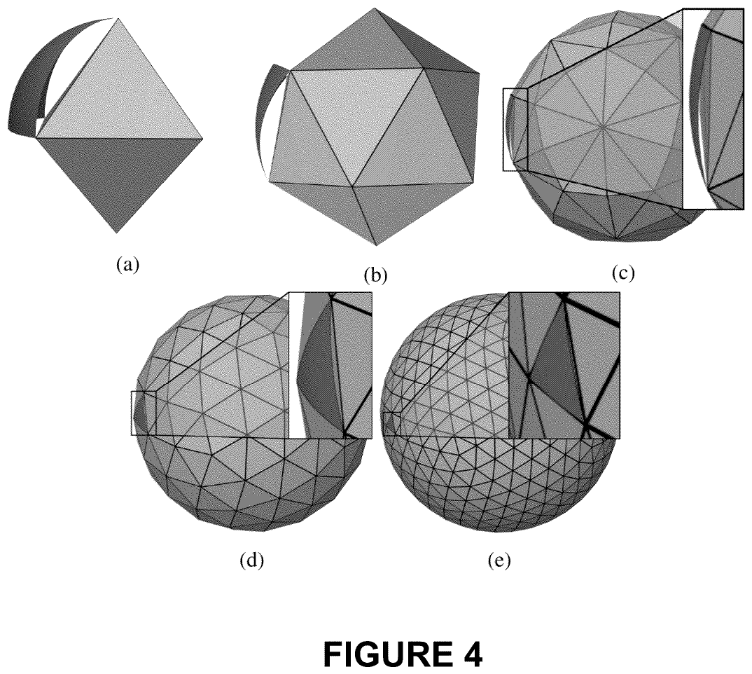

FIG. 4 shows that by increasing the resolution of the base polyhedron, distortion can be reduced. The decrease in distortion from the (a) octahedron to the (b) icosahedron is evident. However, this decrease continues to the (c) disdyakis triacontahedron and also through the (d) pentakis dodecahedron and the (e) a spherical mesh with 240 faces.

As noted above, objects of the subject system are to construct a DGGS capable of handling the modern era's high-volume, high-velocity data sets where the core operations (listed in section 3.2) are extremely efficient to accomplish these objectives. One of the main causes of inefficiencies in a DGGS is the projection and its inverse [6]. Both projection and its inverse are used in the DGGS geocoding pipeline, which is an integral part of processing data with a DGGS (see FIG. 3 as an example process). For example, points must be projected to the polyhedron to determine which cell contains the point. After the planar operations are finished, the point and the cell geometry must be inverse-projected back to the globe for visualization or further processing with spherical operations.

Most DGGS choose a projection based on its ability to reduce or eliminate some form of distortion, and the most common projection methods are area-preserving projections. To preserve area, these projection methods heavily use trigonometric equations that commonly require solving non-linear equations through iterative methods [6]. Therefore, the constant use of projection and inverse-projection in processing high-resolution geospatial big data becomes expensive in terms of computing resources and time, and it has been a common source of inefficiency in many low-distortion DGGS [6]. Because of this, efficiency-first DGGS use simpler projections, such as the gnomonic projection, instead of area-preserving projections. The gnomonic projection is not only efficient; it maintains geodesic cell edges in both spherical and polyhedral spaces. However, gnomonic projection has angular and areal distortion (see FIG. 1). In contrast to the gnomonic projection, area-preserving projections avoid areal distortion but are inefficient. In addition, they still have angular distortion and will necessarily distort cell edges in spherical space, resulting in non-geodesic DGGS cell edges (see FIG. 1).

FIG. 4 shows how the overall distortion present in a DGGS is not only related to the projection method but is also closely related to how well the planar face represents its spherical counterpart. Using this visual intuition, the subject system reduces distortion levels by using a sufficiently high-resolution base polyhedron. With distortion reduced in this way, a more efficient projection method can be used.

As such, the subject system uses a piecewise gnomonic projection with a simple, efficient geometric implementation. Projection and inverse projection are defined between the base polyhedron's planar triangles and the spherical triangle counterpart. Projection from the spherical triangle to the planar face is determined by constructing a ray emanating from the point on the spherical domain towards the origin. This ray is intersected with the polyhedral face using the ray-plane intersection. This is described as:
a. Let n be the normal to the polyhedral face.
b. Let a be a point on the face, for example, one of the vertices of the polyhedral face.
c. Let p be the point that is be projected, which is assumed to be a unit vector.

From this, the projected point p′ is found by scaling p by s which is calculated as follow:

$$s = \frac{a \cdot n}{p \cdot n} [ 63 ] .$$

Inverse projection is a direct inversion of this scaling. For a unit sphere, this is equivalent to normalizing the point

$$( \tilde{p} = \frac{p}{‖ p ‖} ) ,$$

which is a highly efficient operation.

This projection is highly efficient and is easily implemented as a CPU operation or using specialized GPUs. The projection is gnomonic within a given base cell by construction.

In addition, let p and q be any points on the sphere within the same base cell, and p′ and q′ be the points projected to the corresponding face of the base polyhedron. In this case, p and p′ will be on the vector emanating from the origin out to p by construction. The same is true for q and q′. The two vectors will uniquely define a plane going through the sphere's origin. The intersection of this plane and the sphere is a great circle and is the geodesic between p and q. Similarly, the plane will intersect the planar face in a line, and this line is the geodesic between p′ and q′. Thus, within any base cell, geodesics on the sphere will be projected to geodesics on the face of the base polyhedron, thus making this a gnomonic projection for that base cell. Taken together, the projection is piecewise gnomonic. Traditional, efficiency-first DGGS use a similar projection method but pair it with a low-resolution polyhedron, resulting in increased distortion. MBD pairs this efficient operation with a high-resolution polyhedron, significantly reducing distortion. However, using a high-resolution mesh will introduce new challenges, such as how to provide efficient core operations.

### 3.1. Initial Polyhedron and Challenges

Traditional DGGS typically use well-known polyhedra such as Platonic, Catalan, and Archimedean solids. These polyhedra have regular face shapes and uniform face sizes, and the faces have symmetries across the edges. To provide efficient point-to-base-cell operations, traditional DGGS will orient the base polyhedron such that specific edges coincide with well-known geodesic lines (equator, prime-meridian, etc.) and then make use of the symmetries and regularity of the polyhedron. Although it can be assumed that the mesh is watertight [64], has spherical topology, all vertices are on a unit sphere, and its faces have the same counter-clockwise orientation, it cannot be assumed anything about the regularity of the faces or symmetry across edges. This lack of regularity and symmetry introduces challenges. These challenges are addressed using data structures and algorithms motivated by those commonly used in Computer Graphics (CG).

The first of these challenges is how to provide an efficient point-to-base-cell operation when it cannot be assumed specific symmetry between the base cells. To address this challenge, a hash encoding data structure modified from CG [8,9,62] is described (Section 3.3).

The second challenge is how to represent and operate on DGGS cells efficiently at high resolutions. Atlas of Connectivity Maps (ACM) [11] are adapted to address this challenge. ACM provides fast spatial traversal methods, but, as with many approaches in CG, ACM is usually implemented as an explicit mesh representation.

Thus, if it is desired to operate on the mesh at a high resolution, the entire mesh, or the entirety of a patch of the mesh, is recursively refined up to the desired resolution, and the resulting high-resolution geometry is stored in memory for the duration of the desired operations. DGGS should simultaneously operate both at a global scale and at a local scale. Global scales can be represented by the base polyhedron directly or after a few refinement iterations. Local scales, however, may require many iterations of refinement. For example, a DGGS using an icosahedral base polyhedron and 1:4 refinement must be refined 22 times to represent cells with an area of approximately 1.4 m² and would have roughly 351 trillion cells. Therefore, it is not practical to store the entire mesh in memory. Instead, ACM is adapted to provide an efficient spatial and hierarchical traversal method and to provide efficient methods for operating on the mesh's geometry at high resolutions without explicitly storing the entire geometry. As such, it is only necessary to store the geometry of the base polyhedron and data structures that represent the connectivity of the base polyhedron. This approach is described in Sections 3.8 and 3.9.

### 3.2. Core Operations

Before a description is provided how to implement the operations efficiently, the operations are listed and described in terms of their purposes and interactions. For the operations, the types (sets/spaces) of the functions are denoted with:
S²—The spherical spatial domain. Points in this domain are unit vectors
P³—The polyhedral domain, using coordinates in R³.
C_{S}—The geometry of a cell in spherical coordinates.
I_{w}—A cell index at resolution w.
Fᵢ—The ith face of the base mesh.
POINTTOBASECELL: S²→I₀—Converts an input unit vector into the index of the base cell (Fᵢ), which contains the point. This operation is fundamental, as it is required to determine which base cell to use for projection.
PROJECTTOPOLYHEDRON: S²→P³—Converts an input unit vector into a point in R³ on the polyhedron's surface. Note that this function must use POINTTOBASECELL to determine which base cell to use for projection.
INVERSEPROJECTTOSPHERICAL: P³→S²—This operation inverts the PROJECT-TOPOLYHEDRON. It converts an input polyhedral point into a unit vector. Note that this function must use POINTTOBASECELL to determine which base cell to use for projection.
POINTTOCELL: W→S²I_{w}—Converts an input unit vector into the index of the cell that contains it at the given resolution, w. Note that for resolutions w=0, this operation is equivalent to POINTTOBASECELL and that for w>0, this operation must use POINTTOBASECELL and PROJECTTOPOLYHEDRON to determine which child cell contains the point. This operation depends on the refinement scheme.
SPHERICALGEOMETRYFROMINDEX: I_{w}→C_{S}—Converts an input index at resolution w into the positions of vertices for the cell within the spherical domain. This operation depends on the indexing scheme.
NEIGHBORS: I_{w}→I_{W} . . . —Converts an input index at resolution w into its edge neighbor cell indices at resolution w. This operation depends on the indexing scheme.
PARENT: I_{w}→I_{w-1}—Converts an input index at resolution w into parent cell index at resolution w−1. This operation depends on the indexing scheme.
CHILDREN: I_{w}→I_{w+1}—Converts an input index at resolution w into its children cell indices at resolution w+1. This operation depends on the indexing scheme.

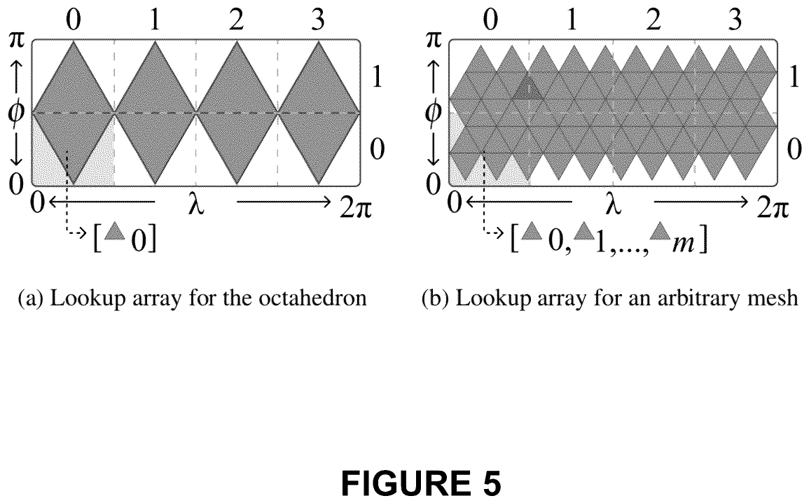

FIG. 5 shows that in the case of an octahedron (a), where each cell is completely contained within an octant, it can be readily determined which cell contains a point by determining which octant the point is within. In the case of an arbitrary mesh (b), the mesh vertices and edges may not be aligned to the latitude/longitude grid, and thus a more general data structure and algorithm must be used.

In the subject system, a hash encoding data structure that supports constant time encoding for high-resolution base polyhedra is used.

### 3.3. Point to Base Cell

Determining which base cell contains a point is one of the most essential operations within a DGGS. For a MBD polyhedral, this operation is performed as a precursor to further data encoding (see FIG. 3) where it is assumed that the base cells are bounded by geodesics in the spherical domain. For the spherical domain, checking to ensure that the point is on the correct side of the planes that define each geodesic is enough.

A naive algorithm for point-to-base-cell is to test all of the base cells in the polyhedron. This algorithm is linear in the number of cells and thus is practical for polyhedra with a small number of cells. This approach is unsuitable for a polyhedron with a large number of cells. To illustrate a proposed hash encoding method, consider a polyhedron with regular cells, such as the octahedron (FIG. 5a). It can be oriented such that each of its faces falls into one octant of the spherical domain. Due to this precise alignment, it is trivial to determine which cell contains a given point p=(λ, ϕ). Alternatively, a simple lookup table can be built that returns the index of the triangle from the octant contained by p=(λ, ϕ) (see FIG. 5a), that can be determined by:

$${i}_{λ}^{′} = ⌊ 4 ( \frac{λ}{2 π} ) ⌋ \qquad ( 1 )$$

$${i}_{ϕ}^{′} = ⌊ 2 ( \frac{ϕ}{π} ) ⌋ .$$

Most DGGS have grid-symmetry and equal-area cells, which allows an efficient bespoke algorithm for this query. In contrast, the subject system cannot depend on such grid symmetries or cell sizes. However, the method based on the look-up array for an octahedron can be generalized for an arbitrary tessellation of the spherical-coordinate domain (FIG. 5b). The idea is to use a lookup grid to precalculate which cells are candidates for a small region of the spherical coordinate domain. Any lookup grid may be used, but a simple one is described with efficient lookup operations in exchange for a larger memory footprint. This data structure resembles a hashing lookup table. To distinguish between the cells of the DGGS and the lookup grid, within this description, the term “bucket” is used to refer to the cells of the lookup grid. To achieve efficient lookups, the grid should be divided into a chosen number of rows, r, and columns, c, (e.g., an r×c array). Generalizing equations 1, where rand c are the number of rows and columns in the bucket-grid, it can be determined which bucket contains the input point:

$${i}_{λ} = ⌊ c ( \frac{λ}{2 π} ) ⌋ \qquad ( 2 )$$

$${j}_{ϕ} = ⌊ r ( \frac{ϕ}{π} ) ⌋ .$$

Each bucket contains a list of candidate DGGS cells, which may contain the point (λ, ϕ). The final step is to iterate through these candidate cells and determine which cell contains (λ, ϕ).

The hash encoding data structure is created as a pre-processing step. The buckets are quads when viewed in (λ, ϕ) domain, and are formed by r+1 horizontal lines of latitude (small circle arcs) and c vertical lines of longitude (great circle arcs). The edges of the polyhedral faces are great circle arcs. Thus, a simple but general method for generating this lookup structure is to compare each bucket with each face in the base polyhedron. The face is included as a candidate if that face intersects the bucket. See FIG. 5b where the darker triangle crosses the edge of a lookup-grid bucket and is included in the candidate list for two buckets.

### 3.3.1. Choosing the Number of Buckets

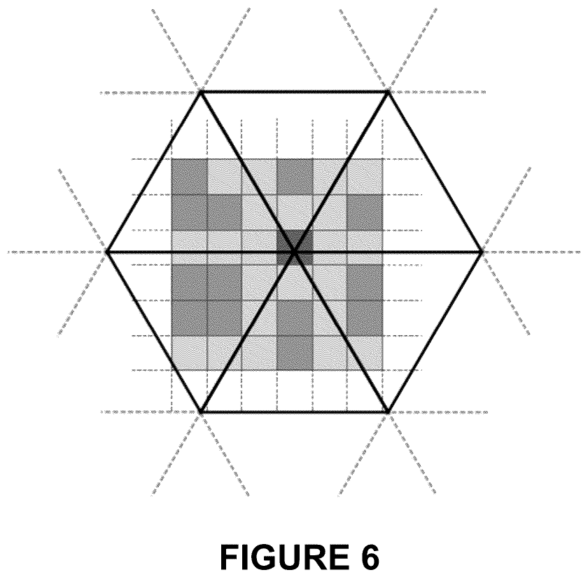

FIG. 6 shows lookup grid-buckets are quads, base polyhedron triangle edges are black lines. Smaller buckets result in fewer cells per bucket. However, no matter how small the buckets are made, there will always be buckets that contain a base polyhedron vertex, buckets that straddle the edges of base polyhedron cells and buckets that are completely contained within a base polyhedron cell.

Accordingly, to achieve good performance, it is desirable to minimize the expected number of cells contained in the buckets. The number of rows and columns in the hash encoding structure dictates the size of the buckets, which, in turn, dictates the expected number of cells found in each bucket. Consider FIG. 5b when the buckets are much larger than the faces of the base polyhedron: each bucket will contain many cells. Reducing the size of the buckets will reduce the number of cells in each bucket. Now consider FIG. 6 when the buckets are much smaller than the faces of the base polyhedron: there are three types of buckets. First are the buckets that contain a vertex from the base polyhedron. These buckets contain all of the cells that share that vertex. Second are the buckets that intersect the edge of a face of the base polyhedron. Each of these contains two or more cells. Third are the buckets that are fully contained within a face of the base polyhedron. Each of these contains a single cell.

Denote the number of cells in a given bucket as |B_{i,j}|, and the number of rows and columns in the lookup grid as rand c, respectively, the expected number of cells in a randomly sampled bucket is the average number of cells across all buckets:

$$EV ( B ) = \frac{{\sum }_{i = 1}^{r} {\sum }_{j = 1}^{c} \vert Bi , j \vert}{r \times c} \qquad ( 3 )$$

Now, consider what happens as the number of rows and columns increase and the buckets become smaller. The number of buckets containing a base polyhedron vertex will remain bounded by a constant. The number of buckets contained fully within a face of the base polyhedron grows much more quickly than the number of buckets crossing cell edges: the total area of the blue buckets approaches the area of the triangle, while the total area of the yellow triangles approaches zero. Thus,

$${lim}_{( r , c ) \to ( ∞ , ∞ )} EV ( B ) = 1$$

Although EV will asymptotically approach 1, practically, EV reaches a value close to 1 very quickly. Experimentally, it was found bucket edges which are 1/10 the length of the smallest edge in the base polyhedron achieve excellent performance with low memory usage (see Tables 14 and 15).

### 3.4. Refinement

Various refinements can be used for triangular cells in a DGGS [2]. A simple 1-to-4 center-aligned refinement was chosen due to the uniformity of the child cells and the implementation efficiency. This refinement inserts new points along the edges and connects them to form 4 new triangles. Note that refinement is performed on the planar face, and the vertices are projected to the sphere afterward.

### 3.5. Indexing

Generally, a model cannot depend on specific properties of the base polyhedron. As a result, the indexing scheme is split into two parts. First, a unique integer i_{b}∈[0, n] is assigned to each of the faces of the base polyhedron. Then, this base-cell index is paired with the resolution w and, if w>0, the triplet of the internal cell index.

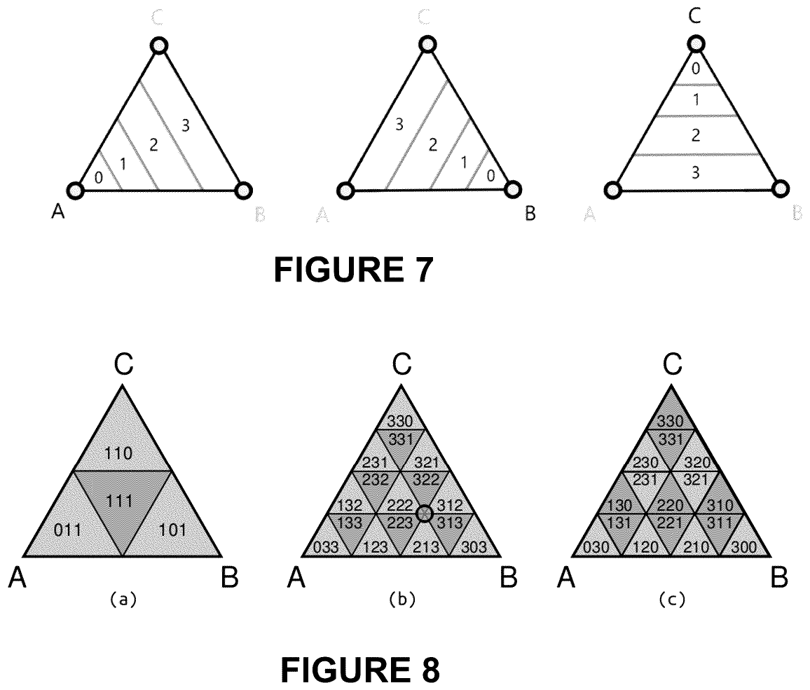

Assuming a triangle is formed from three points v_{A}, v_{B}, and v_{C}, any point p within the interior of this triangle can be expressed by three coordinates α, β, and γ where p=αv_{A}+βv_{B}+γv_{C} and 1=α+β+γ. This is equivalent to a 3D coordinate domain with three basis vectors and is called the normalized barycentric coordinates of a triangle. These coordinates naturally emit an indexing scheme [10,33,65]. To use these as integer cell indices, there are r=2^{w} rows in each basis direction at resolution w (see FIG. 7), then scale each of the coordinates by rand round down. This results in a unique set of indices for each cell (see FIGS. 8 (a) and (b)). However, the function is not onto: some coordinates are syntactically valid indices, such as 113, but do not represent a cell. This is due to using three basis vectors to represent a 2D domain.

FIG. 7 shows the barycentric rows within a base-cell at resolution 2 for v_{A}, v_{B}, and v_{C} respectively.

FIG. 8 shows indices for internal cells at resolution (a) 1 and (b) 2. (c) Triangle pairs with duplicate indices if directly using two-dimensional barycentric indexing. 1 bit of information is necessary to disambiguate between the triangles.

Normalized barycentric coordinates are uniquely determined by only two of the three coordinates because the third can be found via γ=1−α−β, resulting in a 2D coordinate system. However, uniqueness within the coordinate system does not directly transfer to the indices (see FIG. 8 (c)). Modifications to this scheme to create an onto function are possible but result in an asymmetric indexing scheme, further complicating indexing operations. Using all three of the coordinates as an index results in symmetry with respect to all three triangle edges and can be efficiently parallelized on modern CPUs through vectorized operations.

In the subject system, a vectorized implementation of this symmetric 3D Barycentric Indexing Method (BIM) is used. Each index has a triplet of values a, b, c where each value represents the number of steps away from the associated base-cell vertex (FIG. 7). The resulting indices in resolutions 1 and 2 are shown in FIGS. 8 (a) and (b). At resolution 1, the middle triangle is 1 step away from all of the base-cell vertices and has an index of 111, while the other three are 1 step away from two vertices and 0 steps away from one vertex, resulting in indices of 011, 101, and 110 respectively. The pattern continues for finer resolutions. The final representation for an index is a struct combining all five components: I={i, w, a, b, c}.

### 3.6. Point To Cell

The point-to-cell operation determines which cell, I, at any given resolution w, contains a point p. The operation must first determine which base cell contains the point using the POINTTOBASECELL operation. Then, it must project the point onto the planar face of the base cell using the PROJECTTOPOLYHEDRON operation. From here, it calculates the barycentric coordinates α, β, and γ. Substantially, any method for calculating barycentric coordinates will work.

Once the barycentric coordinates are determined, they are converted into the index at the appropriate resolution. The basic idea is to scale the barycentric coordinates by the number of rows at the given resolution and round down. However, it is noted that row numbers are inverted with respect to the barycentric coordinate, so the ordering of the rows is reversed.

Indices are found by calculating how many rows there are in each coordinate direction for the given resolution w:

$$r = {2}^{w} . \qquad ( 5 )$$

Each of the a, b, and c indices are calculated with: a=[(1−α)r], b=[(1−β)r], and c=[(1−γ)r]. Implementation of these operations is vectorized on modern CPUs.

When the incoming point p is on the edge of a child cell or the vertex of a child cell, there may be ambiguities as to which cell should contain the point. For the edge case, the larger index is taken, which uniquely and consistently assigns points on the edge to one of the cells. However, when p is on a vertex of a child cell, an incorrect index may be calculated using the above method. For example, consider FIG. 8 (b) and consider the highlighted vertex adjacent to cells 222, 322, 312, 313, 213, and 223. This vertex will have the barycentric coordinates of α=0.25, β=0.5, γ=0.25 and the number of rows at this level of resolution is 4. Using the above formula, an index of 323 is calculated, which is not an index of any adjacent cells. This is due to the calculation always using the larger value for the index when the point is on an edge, and in this case, the point is on three edges, and the higher value is used for all three. This case can be detected because the sum of the indices in all of the cells is always either 2^{W+1}−2 or 2^{W+1}−1 due to the barycentric coordinate condition of 1=α+β+γ and the use of the floor function. Thus, if the sum of the indices is larger than this value, one of the indices is decremented by one. Additionally, if the sum of the indices is smaller than this value, one of the indices is incremented by one. For the example of 323, it is larger than allowed, and one of the triplet values is decremented. All of 223, 313, and 312 are valid indices, and any of them can be chosen. Arbitrarily, the third index value is chosen to decrement or increment unless that index is 0 or r−1, at which point a switch to the second index is made.

3.7. Spherical Geometry from an Index

This operation is responsible for generating the geometry of the cell in the spherical domain. It is typically accomplished by generating vertices in the planar domain using the planar refinement and then using INVERSEPROJECTTOSPHERICAL to project the points back to the spherical domain. Generation of the geometry for visualization purposes is an essential part of many geospatial data processing pipelines, and having an efficient way to generate the geometry of the cells is, therefore, important. Equal area DGGS use area-preserving projections, distorting the edges of descendent cells into curved non-geodesics in the spherical domain. These types of DGGS must address this issue; for example, they may heavily sample the edges to better approximate the true shape of the cell, which is an expensive operation. The subject system projection avoids this pitfall, because the projection maps polyhedral edges as geodesics in the spherical domain. Maintaining geodesic edges, combined with the efficiency and simplicity of this approach, is a justification for using the barycentric-based indexing scheme and pairing it with a simple projection that maintains geodesics.

In this section, a method to generate spherical geometry with a simple and efficient algorithm that produces the exact spherical cell geometry for an index is described.

The basic idea is that from the regularity of the triangle grid in the plane, a simple algebraic operation to determine the vertices in the plane and inverse project them to the sphere to obtain a representation of the exact spherical geometry of a given cell is undertaken. Given an input cell the base-cell I and its vertices v_{A}, v_{B}, and v_{C} is determined. From here, the number of rows r, at this resolution, is calculated using equation 5. Recall that each barycentric coordinate has a domain of [0,1] and the sum of barycentric coordinates is 1. Each triangle is either oriented in the same manner as the base cell or in the opposite manner (see FIG. 8). The orientations of the triangles can be distinguished by checking if the sum of the child indices is even or odd. A step size is calculated:

$$s = \frac{1}{r} .$$

For a cell with the same orientation as the base cell, the vertex in the lower left-hand corner (relative to FIG. 8) is initially calculated. These barycentric coordinates for the first vertex can be directly calculated from the indices:

$$α = 1 - \frac{a}{r} , β = 1 - \frac{b + 1}{r} , and γ = 1 - ( α + β )$$

This first vertex is calculated as a linear combination of the base cell vertices: v₀=αv_{A}+βv_{B}+γv_{C}. The second and third vertices are calculated as shifted versions of the first vertex: v₁=(α−s)v_{A}+(β+s)v_{B}+γv_{C} and v₂=(α−s)v_{A}+βv_{B}+(γ+S)v_{C}. similar calculation for a cell with the opposite orientation but start with the vertex in the upper right-hand corner is performed.

### 3.8. Spatial Traversal Within a Base Cell

This operation generates the indices of the cells that share an edge with a given cell I at the same resolution w. The basic idea is to increment or decrement one of the barycentric indices to find each neighboring cell. Determining whether to increment or decrement is related to the orientation of the cell with respect to its base cell.

Descendent cells with the opposite orientation relative to their base cell will not have edge neighbors that cross a base-cell boundary, for example, 233 in FIG. 8 (b). To calculate the indices of the neighbors for these cells, one is subtracted from each of a, b and c. Thus, the three neighbors are: I₀={i, w, a−1, b, c}, I₁={i, w, a, b−1, c}, and I₂={i, w, a, b, c−1}.

Descendent cells with the same orientation as the base cell may have edge neighbors that cross a base-cell boundary (e.g. 312 in FIG. 8 (b)). Neighbors across base-cell boundaries are discussed in the following section. For cells that do not cross the base-cell boundary (e.g. 222 in FIG. 8 (b)), one is added to each of a, band c. Thus, the three neighbors are: I₀={i, w, a+1, b, c}, I₁={i, w, a, b+1, c}, and I₂={i, w, a, b, c+1}.

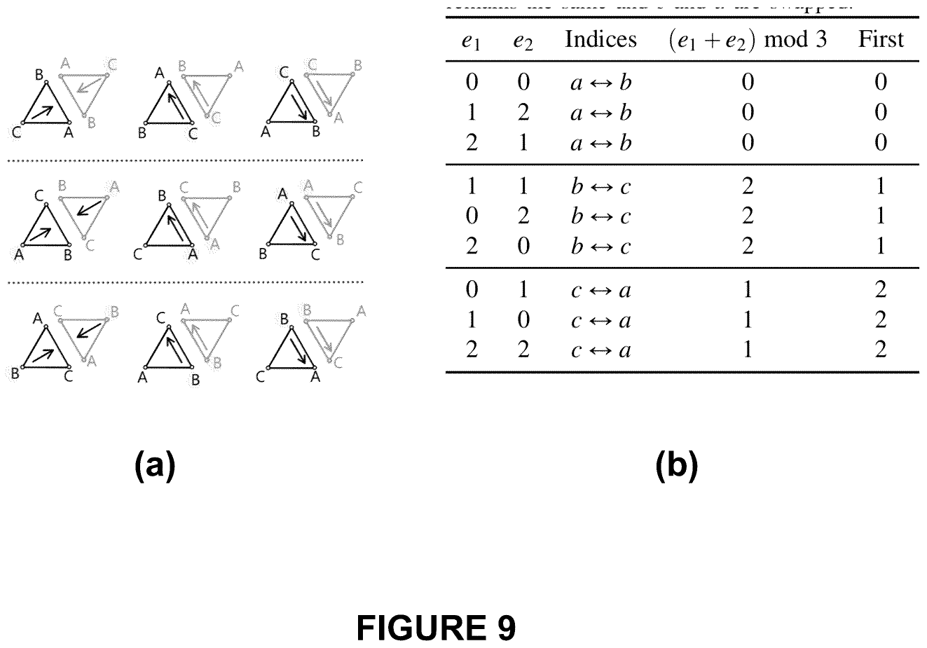

FIG. 9 shows when converting descendant indices to a neighboring coordinate system, the index for one axis will remain the same, and the index for the other two axes must be swapped. In the top row, c remains the same, and a and b are swapped. In the middle row, a remains the same, and b and c are swapped, and finally, in the last row, b remains the same and c and a are swapped.

In addition (See 9(b)), if the edges are numbered and summed, the edge number for each of the cells modulo 3, then the same value for each edge combination that needs the same swap is obtained.

### 3.9. Spatial Traversal Across Cell Boundaries

Descendent cells with the same orientation as the base cell may have edge neighbors that cross over into a neighboring base cell. These cells can be detected by noting that one of the triplet values of a, b, or c is r−1 (e.g. 033 or 312 in FIG. 8 (b)).

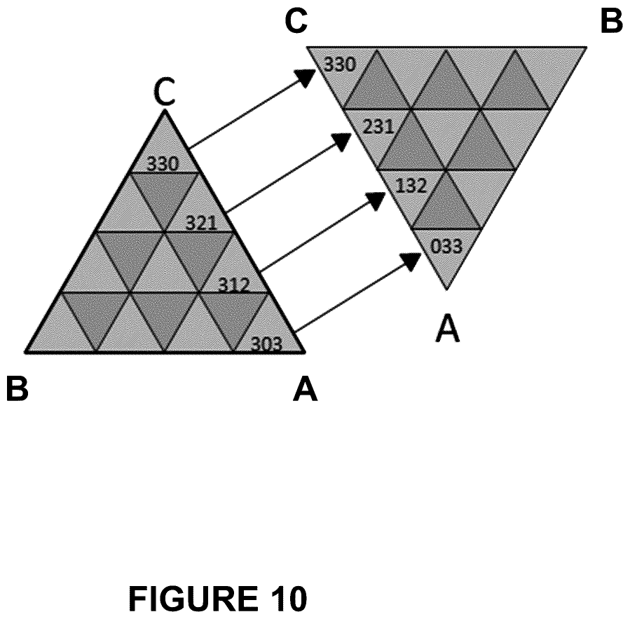

FIG. 10 shows that when cell neighbors cross the edge of a base cell, one of the values in the triplet is unchanged, and two values will swap places. In this figure, the c value stays the same and the a and b swap places.

FIG. 10 also shows that the indices which have edge neighbors that cross over the base-cell edge v̅_̅{̅A̅}̅v̅_̅{̅B̅}̅ are 033, 132, 231 and 330. FIG. 10 shows that the indices that have edge neighbors that cross over a base-cell edge v̅_̅{̅B̅}̅v̅_̅{̅C̅}̅ are 303, 312, 321 and 330. If two base cells that share an edge, and for the first cell the shared edge is v̅_̅{̅C̅}̅v̅_̅{̅A̅}̅, and for the second cell the shared edge is v̅_̅{̅A̅}̅v̅_̅{̅B̅}̅, then, the neighboring indices across that edge will have the following pattern: the c value remains the same and the a and b values swap positions.

FIG. 9a shows that faces are defined in a counterclockwise order. Thus, there are only nine possible transitions across an edge, and in each one, one of the axes is parallel and either points towards the shared edge (the left column) or points along the shared edge in the same direction (the middle and right columns). FIG. 9a enumerates these possibilities and shows that the nine possibilities can be organized into three groups where the same index is static within each group, and the other indices are swapped.

The next step is to find an efficient way to calculate which indices should be swapped. If the edges 0, 1, and 2 for v̅_̅{̅A̅}̅v̅_̅{̅B̅}̅, v̅_̅{̅A̅}̅v̅_̅{̅B̅}̅, and v̅_̅{̅C̅}̅v̅_̅{̅A̅}̅ respectively are denoted and the connected edges modulo 3 are summed, the same answer for each scenario in the same group (See 9(b)) will be obtained. Thus, an equation that efficiently maps 0→0, 2→1, and 1→2 is used. This can be done via a straightforward if statement or the following bitwise operations. Assuming v is bitwise or, Λ is bitwise and, ⊕ is bitwise exclusive or, is shifting bits towards the least significant bit, and <<is shifting bits towards the most significant bit, and j is the sum of the edge indices, modulo 3, then the operations are:

$$x = ( j ⪢ 1 ) ⊕ ( j ∧ 1 ) \qquad ( 6 )$$

$$j = j ⊕ ( ( x ⪡ 1 ) ∨ x )$$

The bits in position j and j+1 modulo 3 are swapped.

### 3.10. Hierarchical Traversal

These operations are responsible for transforming a parent index into its children indices or a child index into its parent index. Due to the barycentric coordinate-based nature of the indexing scheme, these transforms are simple arithmetic.

Assume an input index is: I_{w}={i, w, a, b, c}. To calculate the parent index for this cell, divide by 2 and take the floor:

$${I}_{w - 1} = \{ i , w - 1 , ⌊ \frac{a}{2} ⌋ , ⌊ \frac{b}{2} ⌋ , ⌊ \frac{c}{2} ⌋ \} .$$

The correctness of this equation is verified by considering FIG. 8 and confirming it for each case.

Calculating the indices of the children cells for the above index is only marginally more complex. The general process is the same for both types of cell orientations, with minor differences. Initially, multiply a, b and c by two. Then, if the input cell's orientation matches the base cell's orientation, 1 is added to each. This solves for the index of the middle child cell. The other three cells have the same index as the middle cell, except each child will have one of a, b and c incremented or decremented depending on the orientation of the input index. If the input index's orientation matches the base cell's orientation, then each is decremented, or it is incremented. The correctness of this equation can also be verified by considering FIG. 8 and confirming it for each of the cases.

### 4. New Base Polyhedrons

The foregoing shows how to efficiently generalize operations for any watertight triangle mesh with spherical topology. As a result, MBD enables the choice of any triangle mesh that exhibits the properties desired. In the subject description, a high-resolution mesh of compact faces with low angle and area distortion is desired for both efficiency and low distortion for a resulting DGGS.

### 4.1. Beyond Platonic and Catalan Solids

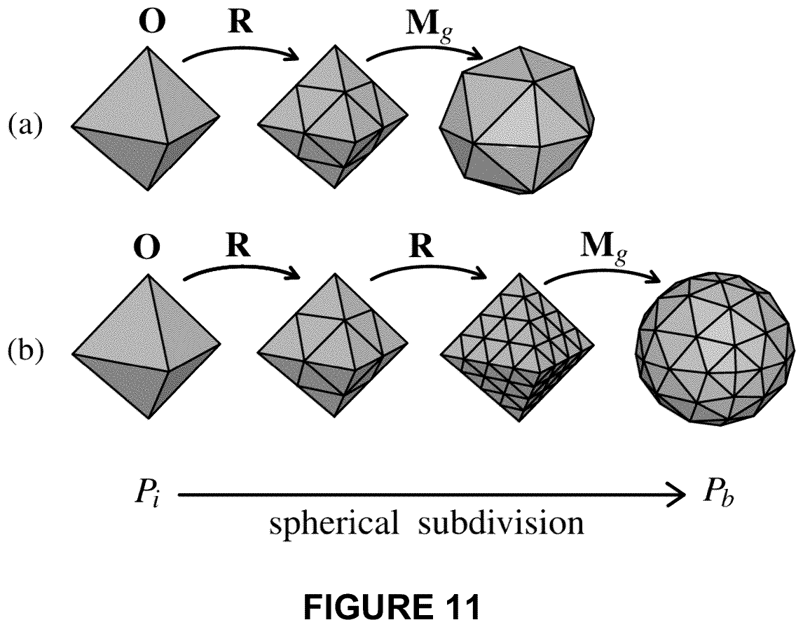

FIG. 11 shows examples of a spherical subdivision pipeline with the following steps. Step (a): is start with an octahedron. Refine it once and then map the vertices to the sphere using gnomonic projection which is denoted: ORM_{g}. Step (b) is refine an octahedron twice and then map the vertices to the sphere using gnomonic projection which is denoted: OR²M_{g}.

One important question for constructing MBD is to find an appropriate base polyhedron beyond traditional Platonic and Catalan solids. As discussed in Section 3, by increasing the resolution of the base polyhedron, one can decrease the overall distortion in the DGGS. In this section, a higher resolution base polyhedron that reduces the overall distortion in the DGGS is discussed. The base polyhedron must have geodesic edges to be a Geodesic DGGS, as this allows for simple planar refinement and efficient Euclidean operations. The geodesic edges are great circle arcs in spherical space and are straight lines in polyhedral space. In this section, polyhedra composed of vertices that lie on the unit sphere are denoted as spherical polyhedra (See FIG. 11 (b) right-most polyhedron). For clarity, the term refined polyhedra for the polyhedra resulting from refinement in Euclidean space (See FIG. 11 (a) middle polyhedron) is used.

All base polyhedra are denoted P_{b}, and are constructed from an input polyhedron, Pᵢ, which has undergone a spherical subdivision process. The spherical subdivision is performed through a combination of refinement to produce a refined polyhedron Pᵣ and a mapping of the vertices of P_{b} to the sphere to create the base polyhedron P_{b} (see FIG. 11). The operations for constructing the output spherical polyhedron P_{b} from the initial polyhedron Pᵢ can be seen as a pipeline of operations. Several platonic solids are considered for Pᵢ and are denoted using the first letter of their name.

For example, Pᵢ=O for the octahedron and Pᵢ=I for the icosahedron. The refinement in polyhedral space is denoted by R (usually 1 to 4 refinement). Mapping the vertices to the sphere is denoted by M with a subscript denoting the specific method. One method for mapping the vertices is gnomonic projection, and this mapping is denoted by M_{g}. The resulting base polyhedron P_{b} is denoted by the input polyhedron followed by the operations used in the pipeline, where a superscript captures repeated operations. For example, FIG. 11 (b) shows an input octahedron refined twice and then mapped to the sphere using gnomonic projection, denoted by: P_{b}=OR²M_{g}.

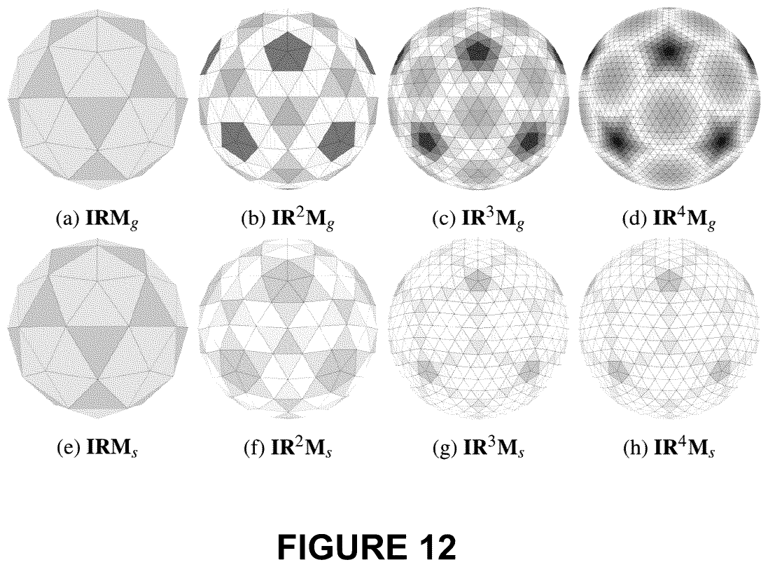

Although the gnomonic projection is one choice, it significantly impacts the area variation in P_{b}. For example, FIG. 12 (a-d) shows the impact of the gnomonic projection on the resulting face size of a refined icosahedron. White denotes the ideal area, grey denotes faces that are larger or smaller than the ideal area. The system can use any mapping for the mesh's vertices, ideally mapping the vertices in a way that increases the area uniformity compared to the gnomonic projection.

Several area-preserving projections can ensure that the area of a polyhedral face is maintained when mapped to the sphere. These projections can preserve area by distorting the edges of the spherical cells into non-geodesic curvilinear edges, which does not satisfy the requirement of geodesic edges for the cells of the base polyhedron. However, an area-preserving projection can be approximated by using the area-preserving projection to map the vertices of the refined polyhedron to the sphere and then connecting the vertices with geodesic edges. This causes some variance in polygon areas due to the differences between the approximating geodesic edges compared to the area-preserving curvilinear edges.

Using a slice-and-dice equal area projection to map the vertices to the sphere and denoting this by Mₛ can be used. FIG. 12 (e-h) shows the results of this process with an icosahedral mesh using the same color scheme as (α-d). Importantly, the resulting polyhedra have significantly increased area uniformity.

In the next section, exact measurements for the area distortion within a suggested P_{b} are described.

### 4.2. Choosing an Initial Polyhedron

There are many options for Pᵢ and, therefore, for P_{b}. Recall that a high-resolution P_{b} is desired because it provides an opportunity to reduce the overall distortion in the DGGS. It is also desired for P_{b} to have compact faces as this allows each cell to be a better representative of the area it bounds [38]. As shown in the subsequent sections, angle and area distortion correlate to the number of faces in the mesh and how well these faces approximate the sphere; thus, higher resolution P_{b} will reduce both angle and area distortion. Additionally, area distortion is also caused by the variance of areas between the cells of P_{b}. Generally, Pᵢ is preferred with more faces, where the faces have equal area and have good compactness. Finally, although polyhedra with triangular faces are required, many polyhedral face types can be easily converted into triangular faces.

The Platonic solids and Catalan solids satisfy the equal area constraint and have good compactness. The icosahedron is a good choice for Pᵢ as it has the most triangular faces of the Platonic solids, and the faces are equilateral triangles, which are the most compact of any triangle. The disdyakis triacontahedron from [29] is another good choice, as it has the most triangular faces with equal area from the Catalan solids. However, its faces are not as compact as the icosahedron. The pentakis dodecahedron is another good choice. It is created by projecting the midpoints of the faces of the dodecahedron to the sphere, resulting in 60 equal-area faces, which are nearly as compact as the icosahedron. Polyhedra across angle distortion, area distortion, and compactness are evaluated and the general trends are discussed. From these trends, polyhedra that make good candidates for a base polyhedron P_{b}, are proposed and then in the following section, performance is benchmarked.

### 4.3. Evaluating Angle Distortion

Angle distortion is defined as in [58]. In this method, a spherical circle (small circle arc) is projected to the face of the polyhedron, which produces an ellipse on the polyhedral face. Then the ellipse's major axis, denoted by a, and its minor axis, denoted by b, are used to calculate the distortion:

$${d}_{θ} = arcsin ( 2 \frac{‖ a ‖ - ‖ b ‖}{‖ a ‖ + ‖ b ‖} ) .$$

This quantity represents the maximum difference in angle between a point on the spherical circle and a point on the planar ellipse [58].

Angle distortion is a continuous infinitesimal function across each base cell which is approximated by sampling the base cell. By using the centers of all descendent cells at resolution 6, provides 4⁶=4096 samples. The circle's radius is set to the minimum distance to one of the cell edges minus a small epsilon. This ensures that none of the sample points of the circle fall into a neighboring base cell. Then, to approximate the major and minor axis, each circle is sampled with 1000 points, projected, and the furthest and closest points from the projected center point are found. Mean, max, and min distortion values are calculated from these samples.

Table 1 lists the angular distortion statistics for the DGGS built with proposed P_{b}, which are all based on the pentakis dodecahedron. The table is sorted in ascending order by the root mean squared error (RMSE). The mean angle distortion in all of proposed meshes is lower than in [29]. It could also be sorted by the number of cells in descending order, indicating that distortion is reduced as the resolution of P_{b} increases. The same trend can be seen in Table 16, which lists the angular distortion statistics for all of the DGGS evaluated through experimentation. This table is also sorted by RMSE, but there is a clear trend of reduced angular distortion as the resolution of P_{b} increases. This confirms part of the initial hypothesis that a higher-resolution base polyhedron can reduce angle distortion.

TABLE 1
Angular distortion in DGGS that use the proposed P_{b} and angular distortion in DGGS
that use the icosahedron, pentakis dodecahedron, and the disdyakis triacontahedron.
It is sorted by RMSE in ascending order. Note that all of the proposed polyhedra
perform better than the Platonic and Catalan solids used in traditional DGGS.

| | | # | Angle distortion (d_{θ}) | | | | |
|---|---|---|---|---|---|---|---|
| | P_{b} | Cells | Mean | Std. Dev. | Min | Max | RMSE ↑ |
| 1 | PR⁴Mₛ | 15360 | 0.00015197 | 0.00001268 | 0.0000000672 | 0.00031720 | 0.00015250 |
| 2 | PR³Mₛ | 3840 | 0.00060005 | 0.00007082 | 0.0000000048 | 0.00125113 | 0.00060421 |
| 3 | PR²Mₛ | 960 | 0.00235199 | 0.00037696 | 0.0000009815 | 0.00511387 | 0.00238201 |
| 4 | PRMₛ | 240 | 0.00908261 | 0.00200213 | 0.0000074163 | 0.02074189 | 0.00930065 |
| 5 | D | 120 | 0.02394044 | 0.00590655 | 0.0000755243 | 0.05292973 | 0.02465813 |
| 6 | P | 60 | 0.03256843 | 0.01019231 | 0.0005006420 | 0.07630611 | 0.03412565 |
| 7 | I | 20 | 0.08747566 | 0.03535058 | 0.0003974214 | 0.21906058 | 0.09434697 |

### 4.4. Evaluating Area Distortion

FIG. 12, (a)-(d) shows P_{b} generated from refining I and mapping with M_{g}. The second row (e)-(h) shows P_{b} generated from refining I and mapping to the sphere with Mₛ. White is the ideal area, shades of grey are larger or smaller than the ideal area.

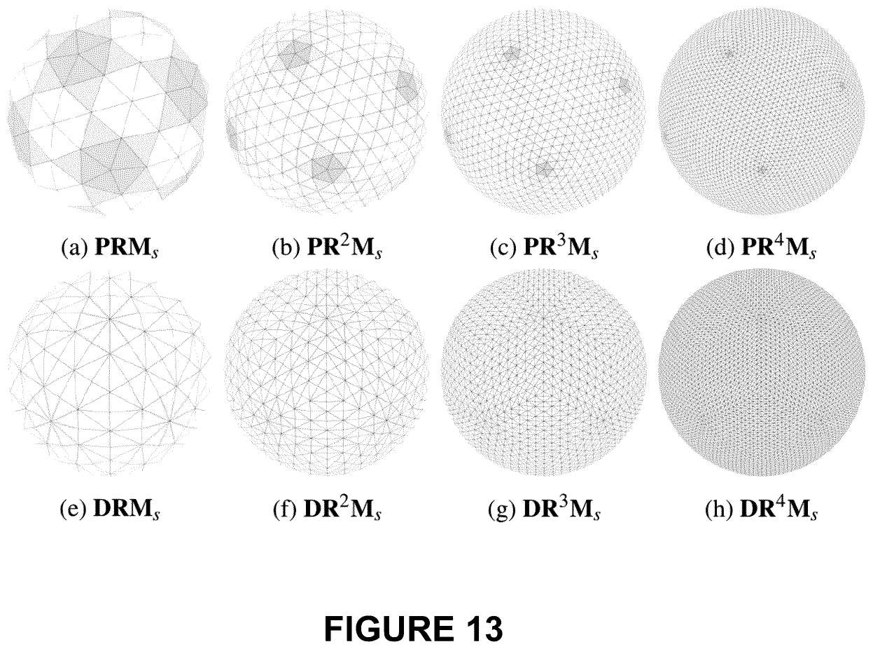

FIG. 13 (a)-(d) shows P_{b} generated from refining P and mapping to the sphere with Mₛ. (e)-(h) shows P_{b} generated from refining D and mapping to the sphere with Mₛ. White is the ideal area, shades of grey are larger or smaller than the ideal area.

The experimental way to approximate area distortion in a DGGS is to heavily sample the boundary of a small area on the sphere (typically a circle) and then project these points to the face of the polyhedron and calculate the area of the resulting polygon in planar space relative to the area of the spherical circle. The sampling is necessary because the projection may not produce geodesics on the face of the polyhedron. However, in the case of the gnomonic projection, geodesics are preserved, and thus, the vertices of any spherical polygon can be projected directly and its planar area calculated. For a polyhedron with Nᵣ faces at resolution r and a surface area equal to a unit sphere, the ideal area of each face at resolution r can be calculated as:

$${A}_{i , r} = \frac{4 π}{{N}_{r}} .$$

The ratio of the area of a given face A_{f,r} to the ideal area can be used as areal distortion metric:

$${d}_{{A}_{r}} = \frac{{A}_{f , r}}{{A}_{i , r}} . \qquad ( 7 )$$

To evaluate this distortion for an entire DGGS, the value for every face at every resolution can be calculated. However, this is computationally prohibitive. Instead, this is approximated by calculating this for every cell at every resolution from 0 to 6:

$${d}_{A} = \frac{{\sum }_{r = 0}^{6} {\sum }_{f = 0}^{{N}_{r}} {d}_{{A}_{r}}}{{\sum }_{r = 0}^{6} {\sum }_{f = 0}^{{N}_{r}} 1} . \qquad ( 8 )$$

Table 2 shows the statistics of this metric for DGGS based on a proposed P_{b} and for DGGS based on the icosahedron (I), pentakis dodecahedron (P) and disdyakis triacontahedron (D). Note that because the area of the mesh will sum to the area of the unit sphere, the mean must be 1 as any increase in area for a cell must be offset by a decrease in area for other cells. Thus, some cells are larger than the ideal area, and some cells are smaller than the ideal area. This table is sorted by RMSE and exhibits the same trend: the RMSE of area distortion decreases as the resolution of P_{b} increases. However, this trend does not continue when the table of all of the P_{b} that were experimentally validated are considered (see Table 17). This table is also sorted by RMSE, but many of the P_{b} with more cells have higher RMSE for area distortion.

This discrepancy is because the area distortion in the DGGS at high resolutions comes from two sources. First, P_{b} may have area variation across its faces. Second, the projection may further distort the areas of the descendent cells. To isolate the distortion due to the P_{b}, equation 8 is used but only for resolution 0. To isolate the distortion due to projection, equation 8 is used with resolutions restricted to resolutions to 1 through 6 and change Aᵢ to be equal to the area of the base cell divided by the number of descendants it has at that resolution. This removes the area variance of P_{b} from the calculation.

Table 2 shows statistics regarding the total area distortion in each of the proposed P_{b}, calculated from all cells from resolution 0 through 6.

TABLE 2

| | | # | Total area distortion (d_{A}) | | | | |
|---|---|---|---|---|---|---|---|
| | P_{b} | Cells | Mean | Std. Dev. | Min | Max | RMSE ↑ |
| 1 | PR⁴Mₛ | 15360 | 1.0 | 0.00663512 | 0.9321378 | 1.03389988 | 0.00663512 |
| 2 | PR³Mₛ | 3840 | 1.0 | 0.01205686 | 0.9311533 | 1.03526341 | 0.01205685 |
| 3 | PR²Mₛ | 960 | 1.0 | 0.02144050 | 0.9272125 | 1.04076141 | 0.02144049 |
| 4 | PRMₛ | 240 | 1.0 | 0.03649345 | 0.9114017 | 1.06349944 | 0.03649339 |
| 5 | D | 120 | 1.0 | 0.03686068 | 0.9016534 | 1.05412000 | 0.03686057 |
| 6 | P | 60 | 1.0 | 0.04720455 | 0.8473916 | 1.06538929 | 0.04720426 |
| 7 | I | 20 | 1.0 | 0.13263882 | 0.6266417 | 1.20630924 | 0.13263639 |

Table 3 shows statistics regarding the area distortion that is caused by the projection itself. Note that it is correlated to the number of base cells.

TABLE 3

| | | # | Area Distortion (d_{A}) due to projection | | | | |
|---|---|---|---|---|---|---|---|
| | P_{b} | Cells | Mean | Std. Dev. | Min | Max | RMSE ↑ |
| 1 | PR⁴Mₛ | 15360 | 1.0 | 0.00018740 | 0.9993186 | 1.00025174 | 0.00018740 |
| 2 | PR³Mₛ | 3840 | 1.0 | 0.00074917 | 0.9972767 | 1.00100359 | 0.00074917 |
| 3 | PR²Mₛ | 960 | 1.0 | 0.00299247 | 0.9891434 | 1.00402191 | 0.00299247 |
| 4 | PRMₛ | 240 | 1.0 | 0.01193254 | 0.9571432 | 1.01631569 | 0.01193252 |
| 5 | D | 120 | 1.0 | 0.03686068 | 0.9016534 | 1.05412000 | 0.03686057 |
| 6 | P | 60 | 1.0 | 0.04720455 | 0.8473916 | 1.06538929 | 0.04720426 |
| 7 | I | 20 | 1.0 | 0.13263882 | 0.6266417 | 1.20630924 | 0.13263639 |

The statistics for the area-distortion due to the projection for the subject DGGS are shown in Table 3. This table is sorted by RMSE and exhibits the same trend: the RMSE of area distortion decreases as the resolution of P_{b} increases. This further confirms that area distortion can be reduced by increasing the resolution of P_{b}. This pattern generally continues in Table 19, which lists the area distortion characteristics for all of the DGGS evaluated in experimentation. The only exceptions to this trend are the P_{b} based on the D, which exhibit slightly worse performance than other meshes with fewer faces due to having less compact faces overall. Compactness is discussed in the next section and how it plays a minor role in predicting area distortion.

TABLE 4

| | | # | Area Non-uniformity (d_{A}) in P_{b} | | | | |
|---|---|---|---|---|---|---|---|
| | P_{b} | Cells | Mean | Std. Dev. | Min | Max | RMSE ↑ |
| 1 | D | 120 | 1.0 | 0.0 | 1.0 | 1.0 | 0.0 |
| 2 | I | 20 | 1.0 | 0.0 | 1.0 | 1.0 | 0.0 |
| 3 | P | 60 | 1.0 | 0.0 | 1.0 | 1.0 | 0.0 |
| 4 | PR⁴Mₛ | 15360 | 1.0 | 0.00663269 | 0.9327243 | 1.03364117 | 0.00663248 |
| 5 | PR³Mₛ | 3840 | 1.0 | 0.01203511 | 0.9335000 | 1.03422711 | 0.01203355 |
| 6 | PR²Mₛ | 960 | 1.0 | 0.02124141 | 0.9366072 | 1.03659233 | 0.02123035 |
| 7 | PRM_{g} | 240 | 1.0 | 0.02765129 | 0.9752723 | 1.04680294 | 0.02759363 |
| 8 | PRMₛ | 240 | 1.0 | 0.03455178 | 0.9491076 | 1.04642628 | 0.03447972 |
| 9 | PR²M_{g} | 960 | 1.0 | 0.04268901 | 0.9162252 | 1.05938730 | 0.04266677 |
| 10 | PR³M_{g} | 3840 | 1.0 | 0.04629791 | 0.8783200 | 1.06260404 | 0.04629188 |
| 11 | PR⁴M_{g} | 15360 | 1.0 | 0.04719219 | 0.8578935 | 1.06505522 | 0.04719065 |

The statistics for the area non-uniformity present in the proposed P_{b} are shown in Table 4 including the area non-uniformity that is caused by the base polyhedron. In addition to the proposed P_{b}, the polyhedron generated by the same process except for the use of the gnomonic projection (M_{g}) instead of approximating slice-and-dice projection (Mₛ) is provided. This table is sorted by RMSE, and while the P_{b} based on Mₛ exhibits the same trend, those based on M_{g} show the opposite trend. This confirms that the approach to approximating an area preserving projection during the construction of P_{b} significantly impacts the area uniformity of the resulting DGGS.

Table 18 has the area non-uniformity characteristics due to the P_{b} for all of the DGGS assessed in experimentation. As expected, I, P and D have uniformity. After these, the order depends primarily on the mapping used, with Mₛ generally performing better than M_{g}. Additionally, the resolution of Pᵢ used also plays a significant role with those based on Pᵢ=D generally outperforming the rest, and those based on Pᵢ=P outperforming those based on Pᵢ=I. Finally, those using M_{g} generally do worse as the resolution increases for the reasons discussed previously.

### 4.5. Evaluating Compactness

For compactness of the faces, Zone Standard Compactness [38] is used. The measure is derived from the isoperimetric quotient, which is the ratio of the area of a face to the square of its perimeter. For fixed perimeter size, the shape with the largest enclosed area is the circle on a unit sphere. For a face f of the DGGS at a given resolution r, this measure depends on the face's spherical area A_{f,r}, the perimeter of the face P_{f,r} and the radius of the sphere R:

$${C}_{f , r} = \frac{\sqrt{4 π {A}_{f , r} - \frac{{A}_{f , r}^{2}}{{R}^{2}}}}{{P}_{f , r}} .$$

Degenerate triangles, where all three vertices lay on the same great circle arc, maximize this measure as they have an area equal to the full hemisphere and a boundary length equal to the length of the great circle arc. Thus, to have a good baseline to compare against, the ideal compactness value is considered to be that of one of the equilateral triangles of the icosahedron: c_{f,0}=0.8245737.

Cell compactness distortion is defined as the ratio of the compactness of each face f at a given resolution r to the ideal compactness value:

$${d}_{f , r} = \frac{{C}_{f , r}}{0.8245737} .$$

To evaluate the compactness of the resulting DGGS, the compactness for each cell is calculated at all resolutions up to resolution 8:

$${d}_{C} = \frac{{\sum }_{r = 0}^{8} {\sum }_{f = 0}^{{N}_{r}} {d}_{f , r}}{{\sum }_{r = 0}^{8} {\sum }_{f = 0}^{{N}_{r}} 1} . \qquad ( 9 )$$

Table 5 shows statistics of the compactness of the cells in the subject DGGS. The compactness is heavily correlated to the compactness of the original faces of the input polyhedron. Thus, the icosahedron generally produces the most compact faces, followed by the pentakis dodecahedron. The disdyakis triacontahedron is a distant last, with the least compact faces of any of them.

TABLE 5

| | | # | Compactness (d_{C}) of the proposed DGGS | | | | |
|---|---|---|---|---|---|---|---|
| | P_{b} | Cells | Mean | Std. Dev. | Min | Max | RMSE ↑ |
| 1 | I | 20 | 0.9418833 | 0.001814312 | 0.9335715 | 0.9999999 | 0.05814499 |
| 2 | PR²Mₛ | 960 | 0.9394006 | 0.001798091 | 0.9335654 | 0.9427323 | 0.06062607 |
| 3 | PR³Mₛ | 3840 | 0.9393582 | 0.001494640 | 0.9335654 | 0.9421862 | 0.06066020 |
| 4 | PR⁴Mₛ | 15360 | 0.9393230 | 0.001398864 | 0.9335654 | 0.9421495 | 0.06069315 |
| 5 | PRMₛ | 240 | 0.9392988 | 0.002400984 | 0.9335652 | 0.9459854 | 0.06074866 |
| 6 | P | 60 | 0.9390448 | 0.001208531 | 0.9335648 | 0.9589797 | 0.06096719 |
| 7 | D | 120 | 0.8737319 | 0.003002320 | 0.8663580 | 0.8827166 | 0.12630373 |

Table 5 contains the compactness statistics of the proposed DGGS and I, P and the D. This table is sorted by RMSE, and the compactness is correlated to the compactness of the base polyhedron. Using equation 9, but restricting the resolution to 0, one can calculate the compactness of P_{b} itself, without the effect of the projection, which is shown in Table 6. The most compact P_{b} is the I, with the D being the least compact. When compared to results in table 5, it can be seen that more faces in P_{b} can offset the reduction in compactness caused by the use of the gnomonic projection in MBD. DGGS based on the proposed polyhedra trend towards compactness of approximately 0.939 and the DGGS based on Pᵢ=I trends towards 0.942 and the DGGS based on D trends towards 0.873. The same trend can be seen in Table 20, which lists the compactness statistics of DGGS based on all of the polyhedra experimentally evaluated. Thus, it can concluded that the compactness of the DGGS based on Pᵢ=P are very close to the compactness of DGGS based on Pᵢ=I, and both are more compact than DGGS based on Pᵢ=D.

Table 6 shows statistics of the compactness of the cells in the proposed polyhedra.

TABLE 6

| | | # | Compactness (d_{C}) of the proposed P_{b} | | | | |
|---|---|---|---|---|---|---|---|
| | P_{b} | Cells | Mean | Std. Dev. | Min | Max | RMSE ↑ |
| 1 | I | 20 | 0.9999999 | 0 | 0.9999999 | 0.9999999 | 0.00000006 |
| 2 | P | 60 | 0.9589797 | 0 | 0.9589797 | 0.9589797 | 0.04102030 |
| 3 | PRMₛ | 240 | 0.9443524 | 0.002962599 | 0.9399114 | 0.9459854 | 0.05570672 |
| 4 | PR²Mₛ | 960 | 0.9406566 | 0.001881837 | 0.9351455 | 0.9427323 | 0.05937139 |
| 5 | PR³Mₛ | 3840 | 0.9396622 | 0.001509109 | 0.9339556 | 0.9421862 | 0.06035641 |
| 6 | PR⁴Mₛ | 15360 | 0.9393913 | 0.001401808 | 0.9336583 | 0.9421495 | 0.06062482 |
| 7 | D | 120 | 0.8819678 | 0 | 0.8819678 | 0.8819678 | 0.11803217 |

Less compact triangles are correlated with higher area distortion. This is demonstrated in Table 19 where DGGS based on Pᵢ=D have higher are distortion than DGGS based on Pᵢ with fewer faces. This follows from the use of the isoperimetric quotient, which is a ratio where the numerator is based on the are of the triangle and the denominator is based on the perimeter of the triangle. If two triangles have the same area, but one is more compact, then the more compact triangle will necessarily have a smaller perimeter. The triangle with the smaller perimeter will better approximate the spherical area that it represents, thus reducing area distortion.

### 4.6. Comparison Between MBD and S2 and H3

Neither S2 nor H3 report distortion statistics for angle, area, or compactness. Additionally, without considerable implementation, it is not possible to evaluate these distortions on S2 and H3 directly. However, it is noted that they are constructed in a way that allows us to reason about their distortion performance.

### 4.6.1. S2

S2 uses a cube as its base polyhedron and uses a two-step projection method [67]. In the first step, points are projected to the faces of the cube using the gnomonic projection. In the second step, the points are projected to another face of a cube in a manner that reduces areal distortion.

The projection does nothing to address the angular distortion of the base polyhedron. Recall the observation that angular distortion is heavily correlated to the number of cells in P_{b} and the projection method itself. S2 projection is a modification of the gnomonic projection, but its modification only improves areal distortion. Thus, it would be expected the angular distortion to be worse than I.

S2 does not report the areal distortion caused by their projection and base polyhedra. However, it does provide documentation pages that list the areal statistics of their cells [68]. To approximate the area variance distribution one can compare the ratio between the maximum and minimum cell areas. Starting at resolution five and going to resolution 30, the ratio of the area of the cells with the maximum and minimum area is approximately 2. This is similar to the same for I which is 1.9. This aligns with expectations based on subject experimental evaluations. Moreover, one would expect the cube combined with the gnomonic projection to be worse than the icosahedron due to having fewer faces, but the second step of their projection improves areal distortion and brings it in line with the icosahedron. This is also significantly higher than many of the DGGS based on the subject P_{b} (see Table 7).

S2 does not report on the compactness of their cells. Based on observation that the compactness of the cells is reduced after projection and that a higher-resolution polyhedron can offset this reduction, one would expect the compactness of S2 cells to be significantly reduced from their ideal square.

### 4.6.2. H3

H3 is based on the icosahedron and uses the gnomonic projection [69]. Although H3 does not report on the angular distortion of their DGGS, one would expect its angle distortion to be nearly identical I. Additionally, while H3 does not report on the areal distortion of their DGGS, they do provide documentation pages which list the areal statistics of their cells [70]. Again, if one takes the ratio of the areas of the cells with the maximum and minimum area, one finds that the ratio is approximately 1.98, which is very similar to I but is slightly worse than the subject 1.9. This is also significantly higher than many of the DGGS based on the P_{b} (see Table 7).

H3 does not report on the compactness of their cells. However, based on the same observation as with S2, one would expect the compactness of the H3 cells to be significantly impacted by the gnomonic projection. This is further confirmed by visually inspecting the images of H3 cells in its documentation [71].

Table 7 shows the ratio of the area between the cell with the largest and smallest areas at high resolutions. MBD can significantly reduce areal distortion compared to competing approaches.

TABLE 7
Max Area / Min Area (Ratio)

| | |
|---|---|
| PR⁴Mₛ | 1.1091 |
| PR³Mₛ | 1.1118 |
| PR²Mₛ | 1.1726 |
| PRMₛ | 1.1668 |
| H3 | 1.9928 |
| S2 | 2.1136 |

### 4.7. Discussion on Recommended Polyhedra

In all evaluated base polyhedra, the angular distortion is correlated to the number of faces of the base polyhedron. This can be viewed in table 16, which is sorted by the RMSE of the angular distortion. It could also be sorted by the number of faces in the polyhedron, and the order would not change. Thus, any of the high-resolution polyhedra suggested are suitable for use as the base polyhedron to reduce angular distortion. However, compactness and area distortion are more interesting. D starts from the most equal area faces, and thus, the polyhedra it emits have the best characteristics in terms of area distortion, but they have the least compact faces. On the other side of the spectrum, I has the fewest faces, and thus, the polyhedra it emits perform the worst in terms of areal distortion, but they have the most compact faces. The P is a good compromise between the two, achieving nearly the same compactness as polyhedra based on I and nearly the same area distortion as polyhedra based on D thus supporting using a high-resolution polyhedron based on P for DGGS which desire a DGGS with low distortion and more compact faces.

### 5. Results and Performance

To experimentally validate the efficiency of the subject system and methods, core operations were benchmarked. Benchmarks were run using the nanobench library [72]. DGGS implementation and the benchmarks are written in C++20 and compiled with GCC 12.3.0 on Ubuntu 22.04. The benchmarks were all run on a 13th-generation Intel Core i9-13900K. SYSTEMD was configured to avoid scheduling other processes on a particular CPU core. All benchmarks were isolated to this same core using TASKSET program, and all benchmarks were run on a single thread. The benchmarks are run on every 2nd level of resolution starting at level 0 and ending on resolution level 24 except for the PARENT operation, which skipped resolution level 0 as there is no parent at that level. These levels of resolution were chosen to be a good representation of the various resolution levels available in both MBD and the DGGS that were compared. For mesh-based DGGS, speed results for PMₛ, PRMₛ, PR²Mₛ, and PR³Mₛ are reported.

To determine the expected performance of the operations for all regions of the DGGS, 10,000 points were randomly sampled across the sphere. Then, each operation was run as a nanobench benchmark for each point at every resolution, and the results stored in a CSV file. The following tables were generated by processing these results in the R programming language to calculate the mean, standard deviation, and 90% quantile. The following figures were also generated by processing these results in the R programming language using the tidyverse [73] and ggstatsplot [74] libraries.

### 5.1. Point to Cell

Point-to-cell operation were compared against Uber's H3 [4] and Google's S2 [3].

Table 8 shows point to cell performance (with conversion from WGS84) for S2, and MBD. Units are in nanoseconds, benchmarked cross 10,000 points.

TABLE 8

| | Mean | Std. Deviation | 90% quantile |
|---|---|---|---|
| DGGS | (ns) | (ns) | (ns) |
| PMₛ | 30.42 | 4.82 | 43.14 |
| PRMₛ | 30.44 | 4.82 | 45.15 |
| PR³Mₛ | 30.46 | 4.89 | 43.80 |
| PR²Mₛ | 30.48 | 4.88 | 44.05 |
| S2 | 39.90 | 0.62 | 47.80 |
| H3 | 265.50 | 89.08 | 548.62 |

Table 9 shows POINTTOCELL performance (without conversion from WGS84) for S2, and MBD. Units are in nanoseconds, benchmarked cross 10,000 points.

TABLE 9

| | Mean | Std. Deviation | 90% quantile |
|---|---|---|---|
| DGGS | (ns) | (ns) | (ns) |
| S2 | 14.17 | 0.23 | 16.15 |
| PRMₛ | 14.23 | 3.24 | 22.13 |
| PR³Mₛ | 14.25 | 3.27 | 28.09 |
| PR²Mₛ | 14.26 | 3.26 | 27.31 |
| PMₛ | 14.27 | 3.29 | 23.55 |

The subject point-to-cell requires access to the point both as a latitude, longitude pair, and a unit-vector in R³. H3 requires the point as a latitude and longitude pair, and S2 requires the point as a unit vector in R³. Most input data will not be received as a unit vector in R³, so S2 and MBD was benchmarked twice, once with the conversion included in the timings and once without the conversion included in the timings. H3 does not provide an alternate form of point-to-cell, so it is not benchmarked twice.

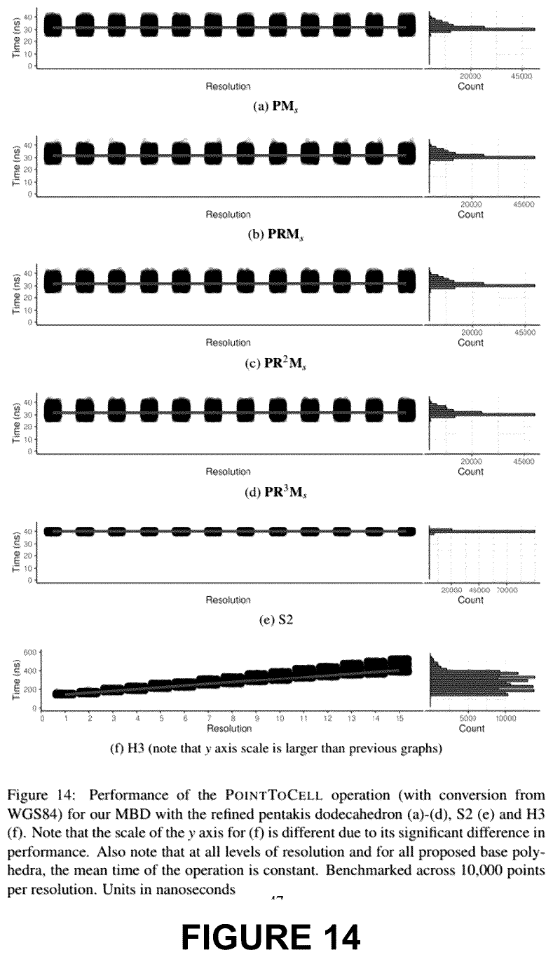

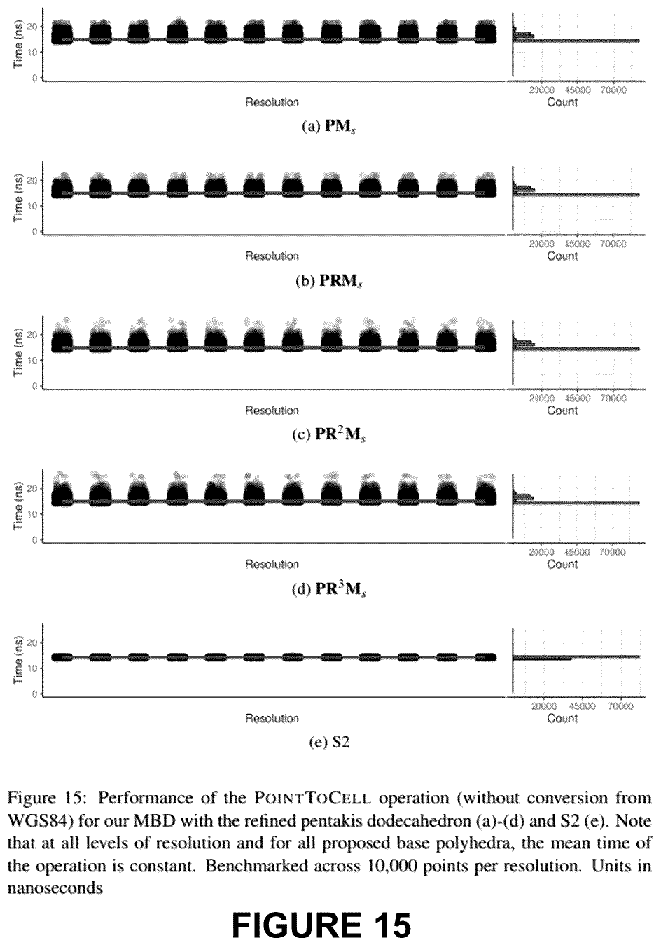

The result for the benchmarking with the conversion from WGS84 (latitude, longitude) is in Table 8 and in FIG. 14. The result for the benchmarking without the conversion from WGS84 (latitude, longitude) is in Table 9 and in FIG. 15. Both demonstrate that MBD is competitive with S2 in terms of speed and is significantly faster than H3. Additionally, the graphs show that the method is constant time and not linear in the resolution, like H3.

5.2. Other operations

Other core operations (CHILDREN, PARENT, NEIGHBOR, and SPHERICALGEOMETRYFROMINDEX) were benchmarked in a similar manner. 10,000 points were randomly sampled across the surface of the earth. Then, for each resolution, POINTTOCELL was run to determine which cell contains that point at that resolution and benchmark the chosen operation for that cell.

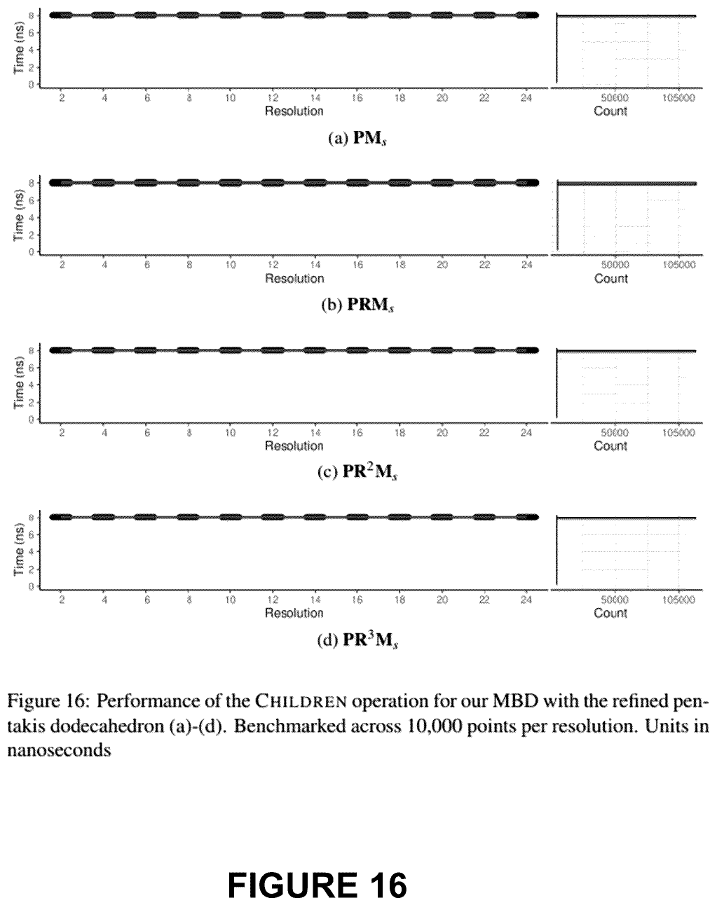

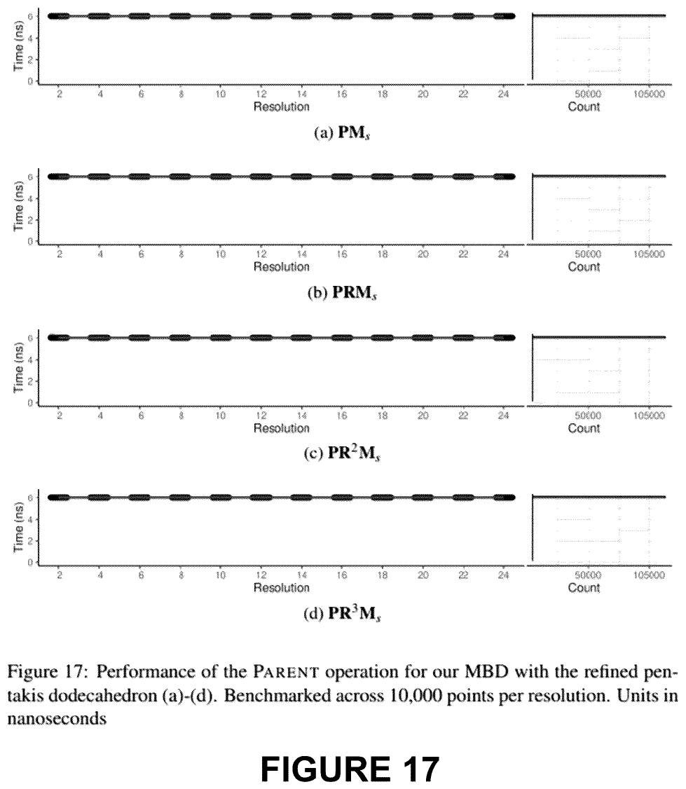

Results for the CHILDREN and PARENT (Section 3.10) operations are in tables 10 and 11 and the associated graphs are in FIGS. 16 and 17. The table and graph for both of these operations show that they are highly efficient and run in constant time even when operating at high resolutions, and even when the base polyhedron is high-resolution.

Table 10 shows performance of the CHILDREN operation in nanoseconds.

TABLE 10

| | Mean | Std. Deviation | 90% quantile |
|---|---|---|---|
| DGGS | (ns) | (ns) | (ns) |
| PRMₛ | 8.02 | 0.00 | 8.07 |
| PMₛ | 8.02 | 0.00 | 8.06 |
| PR²Mₛ | 8.02 | 0.01 | 9.01 |
| PR³Mₛ | 8.02 | 0.00 | 8.84 |

Table 11 shows performance of the PARENT operation in nanoseconds.

TABLE 11

| | Mean | Std. Deviation | 90% quantile |
|---|---|---|---|
| DGGS | (ns) | (ns) | (ns) |
| PMₛ | 5.62 | 1.36 | 6.71 |
| PR³Mₛ | 5.62 | 1.36 | 6.03 |
| PR²Mₛ | 5.62 | 1.36 | 6.28 |
| PRMₛ | 5.62 | 1.36 | 7.73 |

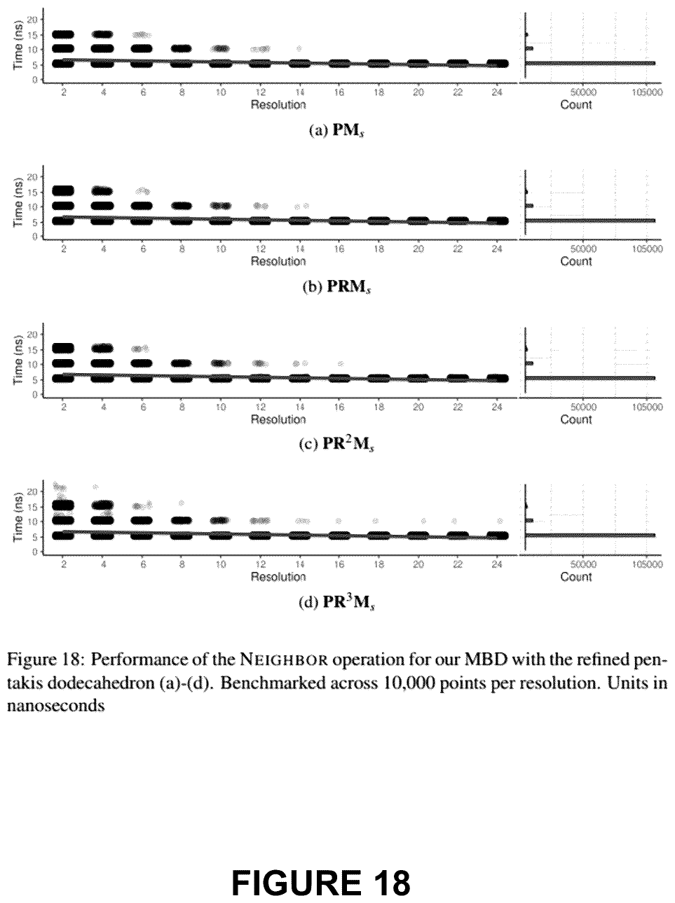

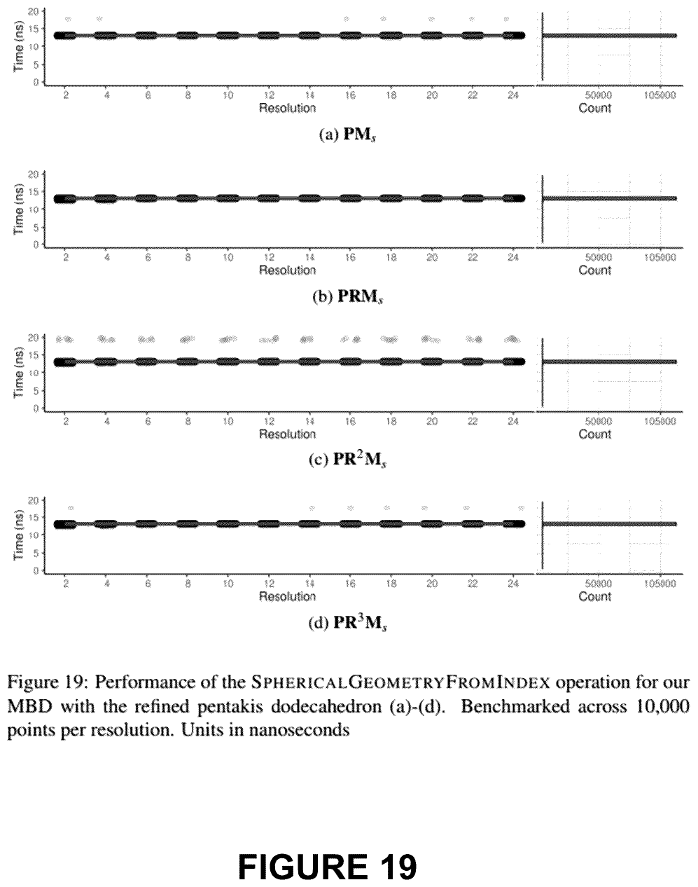

Results for the NEIGHBOR operation (Section 3.8) are in table 12 and the graphs are in FIG. 18. The graph and table for this operation demonstrate that there are three cases, each of which is efficient and constant time. The three cases are:
The cell has no neighbors in an adjacent base cell.
The cell has one neighbor in an adjacent base cell.
The cell has two neighbors in an adjacent base cell.

Each case is constant time, with each subsequent neighbor across a base cell adding a constant amount of time to the operation. Also, it is noted that the expected number of cells in each category changes at increased resolutions. The number of those with no neighbors in a neighboring base cell will increase more quickly than the other two, and the graphs confirm that this category of points dominates at high resolutions. Thus, the expected runtime of the NEIGHBOR operation decreases at increased resolutions. This table and these graphs also confirm that the NEIGHBOR operation is constant time even when using a high-resolution base polyhedron.

The SPHERICALGEOMETRYFROMINDEX operation results are in table 13. The table and graph for this operation show that it is constant time, even when operating at high resolutions and even when the base polyhedron is high-resolution.

These graphs and tables show that MBD operations have extremely efficient constant-time operations. This efficiency continues to be present even with dealing with high-resolution data or using a high-resolution base polyhedron.

Table 12 shows performance of the NEIGHBOR operation in nanoseconds.

TABLE 12

| | Mean | Std. Deviation | 90% quantile |
|---|---|---|---|
| DGGS | (ns) | (ns) | (ns) |
| PMₛ | 5.42 | 1.84 | 15.36 |
| PRMₛ | 5.44 | 1.89 | 16.09 |
| PR³Mₛ | 5.44 | 1.91 | 22.89 |
| PR²Mₛ | 5.44 | 1.91 | 16.10 |

Table 13 shows performance of the SPHERICALGEOMETRYFROMINDEX operation in nanoseconds.

TABLE 13

| | Mean | Std. Deviation | 90% quantile |
|---|---|---|---|
| DGGS | (ns) | (ns) | (ns) |
| PRMₛ | 12.27 | 2.99 | 13.20 |
| PR³Mₛ | 12.27 | 2.99 | 17.91 |
| PMₛ | 12.27 | 2.99 | 17.91 |
| PR²Mₛ | 12.28 | 2.99 | 19.83 |

### 5.3. Results: Memory Usage

Memory used in the subject implementation of MBD is discussed in Appendix section 8.1 which shows that hash-encoding lookup structure represents the bulk of the memory usage and that the size of the buckets in this structure is directly correlated to the number of buckets, which is directly correlated to the memory usage. The number of buckets depends on the heuristic used to choose how many times one should partition the latitude and longitude ranges for the partitioning structure. This parameter can be modified to control the memory usage of the hash-encoding lookup structure. In table 14, a factor of 0.1 is used and reported on the number of partitions, the size of the hash-encoding lookup structure, and the size of the resulting DGGS which shows that all of the suggested DGGS fit within the cache size of modern CPU architectures, and thus, Mesh-based DGGS is highly efficient.

### 5.4. Results: Expected Cells Per Bucket

As discussed in Section 3.3.1, the size of the bucket grid also impacts the expected number of cells found in each bucket. Table 15 shows that the mean number of cells per bucket in the proposed lookup grids is around 1.25. This value is close to 1, as expected. The value can be made smaller by using more buckets (which will increase memory usage) or larger by using fewer buckets (which will decrease memory usage). Furthermore, this table also lists the minimum number of cells per bucket and the maximum number of cells per bucket. The minimum number of cells per bucket is 1, indicating that many buckets contain exactly one cell. The maximum number of cells per bucket is 6, which is the valence of the pentakis dodecahedron, which further confirms that the hash-encoding structure has predictable and controllable behavior with regard to memory usage and efficiency.

Table 14 shows the memory usage of the recommended base polyhedra. As the resolution increases, so does the number of partitions used for latitude (rows) and longitude (columns). The hash-encoding lookup structure represents most of the memory usage, as expected. Each level of refinement introduces four times more faces, which increases memory usage by approximately four times as well.

TABLE 14

| | |
|---|---|
| Lookup Grid | Memory usage (MB) |

| DGGS | Rows | Cols | Lookup | Total |
|---|---|---|---|---|
| P | 69 | 137 | 0.13 | 0.14 |
| PRMₛ | 139 | 277 | 0.51 | 0.58 |
| PR²Mₛ | 278 | 555 | 2.06 | 2.32 |
| PR³Mₛ | 555 | 1109 | 8.22 | 9.24 |

Table 15 shows the mean expected cells per bucket in the hash-encoding lookup structure. As expected, the value is close to 1.

TABLE 15

| | Lookup Grid | | Expected cells per bucket | | |
|---|---|---|---|---|---|
| | Rows | Cols | Mean | Min | Max |
| PMₛ | 69 | 137 | 1.25 | 1 | 6 |
| PRMₛ | 139 | 277 | 1.29 | 1 | 6 |
| PR²Mₛ | 278 | 555 | 1.27 | 1 | 6 |
| PR³Mₛ | 555 | 1109 | 1.25 | 1 | 6 |

### 5.5. Performance of Recommended Polyhedrons

In this section, it is shown that MBD operations are constant time and do not depend on the number of faces in the base polyhedron or the resolution being used. Additionally, it is shown that an operations' speed is competitive or better than S2 and significantly better than H3 enabling the choice of any P_{b}. One can use a very high-resolution base polyhedron such as PR³Mₛ if distortion must be minimized. If data must be represented at coarse representations and distortion is less of a concern, one can use a lower resolution base polyhedron, such as P.

Modern CPUs tend to have anywhere from a few MB to hundreds of MB of high-performance cache that can be used to speed up operations. In table 14, the total memory usage of the DGGS and its lookup structure for the recommended base polyhedron is shown. The primary consideration for memory usage is the impact of this on cache sizes for modern CPUs. When the data needed fits within the CPU cache, performance can be drastically improved. The table demonstrates that the DGGS memory footprint is well below the CPU cache sizes for modern CPUs. Thus, Mesh-based DGGS can achieve high performance when many operations are performed in sequence.

### 6. Conclusions

In summary, the foregoing describes a novel system and method for constructing efficient, low-distortion DGGS. High-resolution base polyhedron can reduce distortion in DGGS to very low levels. It has been shown how to efficiently generalize the core operations of a DGGS to any given watertight triangular mesh with spherical topology. A new hash encoding structure to speed up the encoding of points into the indices of the DGGS is described and demonstrated that the approach is competitive with existing DGGS. Core DGGS operations are benchmarked to show they are constant time and efficient even at high resolution. New polyhedra with lower angular and areal distortion than the base polyhedra used in traditional DGGS are introduced.

### 6.1. Compactness

It is noted that both quads and hexagons are known to be more compact than triangles. However, it is noted that the subject methods for efficient operations with triangles should directly apply to quads. For example, each quad can be split into two triangles and treated identically, and the subject methods can be modified to work in this scenario. Using the MBD approach with a high-resolution quad mesh will reduce the overall areal and angular distortion compared to S2 while maintaining efficient operations.

In addition, MBD can be extended to work with hexagonal meshes. Starting from a higher resolution hexagonal mesh would reduce the overall areal and angular distortion in DGGS. The subject hash-encoding lookup structure can be used directly to provide efficient point-to-base-cell lookups.

TABLE 16
The statistics of the angle distortion for our proposed P_{b}. Note
that the angle distortion is heavily correlated with the number
of faces with a small correlation to the compactness of the faces.

| | | # | Angle distortion (d_{θ}) | | | | |
|---|---|---|---|---|---|---|---|
| | P_{b} | Cells | Mean | Std. Dev. | Min | Max | RMSE ↑ |
| 1 | PR⁴Mₛ | 15360 | 0.00015197 | 0.00001268 | 0.0000000672 | 0.00031720 | 0.00015250 |
| 2 | PR⁴M_{g} | 15360 | 0.00015812 | 0.00001372 | 0.0000000143 | 0.00033239 | 0.00015871 |
| 3 | DR³Mₛ | 7680 | 0.00045170 | 0.00003553 | 0.0000003333 | 0.00094537 | 0.00045310 |
| 4 | IR⁴Mₛ | 5120 | 0.00045846 | 0.00004373 | 0.0000003256 | 0.00095173 | 0.00046054 |
| 5 | I(RM_{g})⁴ | 5120 | 0.00051047 | 0.00005946 | 0.0000002938 | 0.00104567 | 0.00051392 |
| 6 | IR⁴M_{g} | 5120 | 0.00051227 | 0.00006343 | 0.0000002560 | 0.00106132 | 0.00051619 |
| 7 | PR³Mₛ | 3840 | 0.00060005 | 0.00007082 | 0.0000000048 | 0.00125113 | 0.00060421 |
| 8 | PR³M_{g} | 3840 | 0.00062444 | 0.00007141 | 0.0000003076 | 0.00128756 | 0.00062851 |
| 9 | DR²Mₛ | 1920 | 0.00175024 | 0.00020732 | 0.0000004734 | 0.00365371 | 0.00176248 |
| 10 | IR³Mₛ | 1280 | 0.00180341 | 0.00026653 | 0.0000031814 | 0.00391202 | 0.00182300 |
| 11 | I(RM_{g})³ | 1280 | 0.00197662 | 0.00031109 | 0.0000016355 | 0.00422846 | 0.00200095 |
| 12 | IR³M_{g} | 1280 | 0.00198462 | 0.00031675 | 0.0000016960 | 0.00422836 | 0.00200973 |
| 13 | PR²Mₛ | 960 | 0.00235199 | 0.00037696 | 0.0000009815 | 0.00511387 | 0.00238201 |
| 14 | PR²M_{g} | 960 | 0.00243047 | 0.00037075 | 0.0000001950 | 0.00520797 | 0.00245859 |
| 15 | DRMₛ | 480 | 0.00673947 | 0.00113270 | 0.0000104195 | 0.01436727 | 0.00683399 |
| 16 | IR²Mₛ | 320 | 0.00701956 | 0.00145779 | 0.0000003850 | 0.01574459 | 0.00716933 |
| 17 | I(RM_{g})² | 320 | 0.00751530 | 0.00156607 | 0.0000130658 | 0.01696597 | 0.00767673 |
| 18 | IR²M_{g} | 320 | 0.00753832 | 0.00156221 | 0.0000185405 | 0.01696612 | 0.00769849 |
| 19 | PRMₛ | 240 | 0.00908261 | 0.00200213 | 0.0000074163 | 0.02074189 | 0.00930065 |
| 20 | PRM_{g} | 240 | 0.00912064 | 0.00200433 | 0.0000209046 | 0.01971010 | 0.00933827 |
| 21 | D | 120 | 0.02394044 | 0.00590655 | 0.0000755243 | 0.05292973 | 0.02465813 |
| 22 | IRMₛ | 80 | 0.02660950 | 0.00779318 | 0.0000009578 | 0.06622138 | 0.02772716 |
| 23 | IRM_{g} | 80 | 0.02660950 | 0.00779318 | 0.0000009580 | 0.06622159 | 0.02772716 |
| 24 | P | 60 | 0.03256843 | 0.01019231 | 0.0005006420 | 0.07630611 | 0.03412565 |
| 25 | I | 20 | 0.08747566 | 0.03535058 | 0.0003974214 | 0.21906058 | 0.09434697 |

TABLE 17
Statistics regarding the total area distortion in each of our
P_{b} due to the initial area non-uniformity and the projection.

| | | # | Total area distortion (d_{A}) | | | | |
|---|---|---|---|---|---|---|---|
| | P_{b} | Cells | Mean | Std. Dev. | Min | Max | RMSE ↑ |
| 1 | PR⁴Mₛ | 15360 | 1.0 | 0.00663512 | 0.9321378 | 1.03389988 | 0.00663512 |
| 2 | DR³Mₛ | 7680 | 1.0 | 0.00719718 | 0.9797803 | 1.02153464 | 0.00719718 |
| 3 | DR²Mₛ | 1920 | 1.0 | 0.01042000 | 0.9779221 | 1.02248567 | 0.01042000 |
| 4 | PR³Mₛ | 3840 | 1.0 | 0.01205686 | 0.9311533 | 1.03526341 | 0.01205685 |
| 5 | DRMₛ | 480 | 1.0 | 0.01362017 | 0.9627823 | 1.02592901 | 0.01362016 |
| 6 | IR⁴Mₛ | 5120 | 1.0 | 0.01858054 | 0.9033260 | 1.06316711 | 0.01858053 |
| 7 | PR²Mₛ | 960 | 1.0 | 0.02144050 | 0.9272125 | 1.04076141 | 0.02144049 |
| 8 | PRM_{g} | 240 | 1.0 | 0.03009671 | 0.9354920 | 1.06407083 | 0.03009667 |
| 9 | IR³Mₛ | 1280 | 1.0 | 0.03225850 | 0.9005473 | 1.07744319 | 0.03225849 |
| 10 | PRMₛ | 240 | 1.0 | 0.03649345 | 0.9114017 | 1.06349944 | 0.03649339 |
| 11 | D | 120 | 1.0 | 0.03686068 | 0.9016534 | 1.05412000 | 0.03686057 |
| 12 | PR²M_{g} | 960 | 1.0 | 0.04277345 | 0.9072334 | 1.06380043 | 0.04277344 |
| 13 | PR³M_{g} | 3840 | 1.0 | 0.04629806 | 0.8762423 | 1.06370923 | 0.04629805 |
| 14 | PR⁴M_{g} | 15360 | 1.0 | 0.04719103 | 0.8573973 | 1.06533280 | 0.04719103 |
| 15 | P | 60 | 1.0 | 0.04720455 | 0.8473916 | 1.06538929 | 0.04720426 |
| 16 | IR²Mₛ | 320 | 1.0 | 0.05517632 | 0.8894081 | 1.08643307 | 0.05517626 |
| 17 | I(RM_{g})⁴ | 5120 | 1.0 | 0.08644592 | 0.9263581 | 1.20656602 | 0.08644591 |
| 18 | I(RM_{g})³ | 1280 | 1.0 | 0.08646478 | 0.9223354 | 1.20656300 | 0.08646475 |
| 19 | I(RM_{g})² | 320 | 1.0 | 0.08676194 | 0.9063684 | 1.20655091 | 0.08676184 |
| 20 | IRM_{g} | 80 | 1.0 | 0.09114404 | 0.8444595 | 1.20650257 | 0.09114363 |
| 21 | IRMₛ | 80 | 1.0 | 0.09114404 | 0.8444595 | 1.20650257 | 0.09114363 |
| 22 | IR²M_{g} | 320 | 1.0 | 0.12040402 | 0.7652965 | 1.20655091 | 0.12040388 |
| 23 | IR³M_{g} | 1280 | 1.0 | 0.13012447 | 0.6890477 | 1.20656300 | 0.13012443 |
| 24 | IR⁴M_{g} | 5120 | 1.0 | 0.13259216 | 0.6474662 | 1.20656602 | 0.13259215 |
| 25 | I | 20 | 1.0 | 0.13263882 | 0.6266417 | 1.20630924 | 0.13263639 |

TABLE 18
Statistics regarding the area non-uniformity caused by P_{b}.

| | | # | Area Non-uniformity (d_{A}) in the base polyhedron | | | | |
|---|---|---|---|---|---|---|---|
| | P_{b} | Cells | Mean | Std. Dev. | Min | Max | RMSE ↑ |
| 1 | D | 120 | 1.0 | 0.0 | 1.0 | 1.0 | 0.0 |
| 2 | I | 20 | 1.0 | 0.0 | 1.0 | 1.0 | 0.0 |
| 3 | P | 60 | 1.0 | 0.0 | 1.0 | 1.0 | 0.0 |
| 4 | PR⁴Mₛ | 15360 | 1.0 | 0.00663269 | 0.9327243 | 1.03364117 | 0.00663248 |
| 5 | DR³Mₛ | 7680 | 1.0 | 0.00717223 | 0.9814637 | 1.02057298 | 0.00717176 |
| 6 | DRMₛ | 480 | 1.0 | 0.00969423 | 0.9873097 | 1.01049364 | 0.00968413 |
| 7 | DR²Mₛ | 1920 | 1.0 | 0.01013952 | 0.9840500 | 1.01863634 | 0.01013688 |
| 8 | PR³Mₛ | 3840 | 1.0 | 0.01203511 | 0.9335000 | 1.03422711 | 0.01203355 |
| 9 | IR⁴Mₛ | 5120 | 1.0 | 0.01857384 | 0.9049809 | 1.06236385 | 0.01857203 |
| 10 | PR²Mₛ | 960 | 1.0 | 0.02124141 | 0.9366072 | 1.03659233 | 0.02123035 |
| 11 | PRM_{g} | 240 | 1.0 | 0.02765129 | 0.9752723 | 1.04680294 | 0.02759363 |
| 12 | IR³Mₛ | 1280 | 1.0 | 0.03219270 | 0.9071713 | 1.07416969 | 0.03218012 |
| 13 | PRMₛ | 240 | 1.0 | 0.03455178 | 0.9491076 | 1.04642628 | 0.03447972 |
| 14 | PR²M_{g} | 960 | 1.0 | 0.04268901 | 0.9162252 | 1.05938730 | 0.04266677 |
| 15 | PR³M_{g} | 3840 | 1.0 | 0.04629791 | 0.8783200 | 1.06260404 | 0.04629188 |
| 16 | PR⁴M_{g} | 15360 | 1.0 | 0.04719219 | 0.8578935 | 1.06505522 | 0.04719065 |
| 17 | IR²Mₛ | 320 | 1.0 | 0.05452483 | 0.9159699 | 1.07325477 | 0.05443957 |
| 18 | IRM_{g} | 80 | 1.0 | 0.08423406 | 0.9516724 | 1.14498294 | 0.08370594 |
| 19 | IRMₛ | 80 | 1.0 | 0.08423406 | 0.9516724 | 1.14498294 | 0.08370594 |
| 20 | I(RM_{g})² | 320 | 1.0 | 0.08641395 | 0.9339726 | 1.19035818 | 0.08627883 |
| 21 | I(RM_{g})³ | 1280 | 1.0 | 0.08646814 | 0.9292853 | 1.20245990 | 0.08643435 |
| 22 | I(RM_{g})⁴ | 5120 | 1.0 | 0.08645245 | 0.9280986 | 1.20553674 | 0.08644401 |
| 23 | IR²M_{g} | 320 | 1.0 | 0.12024577 | 0.7848607 | 1.19035818 | 0.12005774 |
| 24 | IR³M_{g} | 1280 | 1.0 | 0.13015502 | 0.6929174 | 1.20245990 | 0.13010417 |
| 25 | IR⁴M_{g} | 5120 | 1.0 | 0.13260386 | 0.6483158 | 1.20553674 | 0.13259091 |

TABLE 19
Statistics regarding the Area distortion that is caused by the projection itself.
Note that it is primarily correlated to the number of base cells. A notable exception
is the D where the low compactness at resolution 0 increases the distortion.

| | | # | Area Distortion (d_{A}) due to projection | | | | |
|---|---|---|---|---|---|---|---|
| | P_{b} | Cells | Mean | Std. Dev. | Min | Max | RMSE ↑ |
| 1 | PR⁴Mₛ | 15360 | 1.0 | 0.00018740 | 0.9993186 | 1.00025174 | 0.00018740 |
| 2 | PR⁴M_{g} | 15360 | 1.0 | 0.00018801 | 0.9992951 | 1.00026063 | 0.00018801 |
| 3 | IR⁴M_{g} | 5120 | 1.0 | 0.00055405 | 0.9976505 | 1.00085379 | 0.00055405 |
| 4 | IR⁴Mₛ | 5120 | 1.0 | 0.00056177 | 0.9979180 | 1.00075610 | 0.00056177 |
| 5 | I(RM_{g})⁴ | 5120 | 1.0 | 0.00056444 | 0.9976505 | 1.00085379 | 0.00056444 |
| 6 | DR³Mₛ | 7680 | 1.0 | 0.00060418 | 0.9982376 | 1.00104192 | 0.00060418 |
| 7 | PR³Mₛ | 3840 | 1.0 | 0.00074917 | 0.9972767 | 1.00100359 | 0.00074917 |
| 8 | PR³M_{g} | 3840 | 1.0 | 0.00075195 | 0.9971912 | 1.00104008 | 0.00075195 |
| 9 | IR³M_{g} | 1280 | 1.0 | 0.00221595 | 0.9906685 | 1.00341226 | 0.00221595 |
| 10 | IR³Mₛ | 1280 | 1.0 | 0.00224309 | 0.9916587 | 1.00304746 | 0.00224309 |
| 11 | I(RM_{g})³ | 1280 | 1.0 | 0.00225618 | 0.9906685 | 1.00341226 | 0.00225618 |
| 12 | DR²Mₛ | 1920 | 1.0 | 0.00241156 | 0.9930414 | 1.00403638 | 0.00241156 |
| 13 | PR²Mₛ | 960 | 1.0 | 0.00299247 | 0.9891434 | 1.00402191 | 0.00299247 |
| 14 | PR²Mₛ | 960 | 1.0 | 0.00300617 | 0.9888503 | 1.00416574 | 0.00300617 |
| 15 | IR²M_{g} | 320 | 1.0 | 0.00886019 | 0.9637018 | 1.01360324 | 0.00886018 |
| 16 | IR²Mₛ | 320 | 1.0 | 0.00893648 | 0.9670541 | 1.01227882 | 0.00893647 |
| 17 | I(RM_{g})² | 320 | 1.0 | 0.00899873 | 0.9637018 | 1.01360324 | 0.00899872 |
| 18 | DRMₛ | 480 | 1.0 | 0.00956758 | 0.9728399 | 1.01550491 | 0.00956757 |
| 19 | PRMₛ | 240 | 1.0 | 0.01193254 | 0.9571432 | 1.01631569 | 0.01193252 |
| 20 | PRM_{g} | 240 | 1.0 | 0.01199818 | 0.9569431 | 1.01649584 | 0.01199816 |
| 21 | IRM_{g} | 80 | 1.0 | 0.03554681 | 0.8692450 | 1.05372973 | 0.03554665 |
| 22 | IRMₛ | 80 | 1.0 | 0.03554681 | 0.8692450 | 1.05372973 | 0.03554665 |
| 23 | D | 120 | 1.0 | 0.03686068 | 0.9016534 | 1.05412000 | 0.03686057 |
| 24 | P | 60 | 1.0 | 0.04720455 | 0.8473916 | 1.06538929 | 0.04720426 |
| 25 | I | 20 | 1.0 | 0.13263882 | 0.6266417 | 1.20630924 | 0.13263639 |

TABLE 20
The statistics of the compactness of the cells in our proposed P_{b}. The compactness
is heavily correlated to the compactness of the original faces of the input
polyhdron. Thus, the icosahedron generally produces the most compact faces,
followed by the pentakis dodecahedron. The disdyakis triacontahedron is
a distant last, with the least compact faces of any of them.

| | | | Compactness (d_{C}) of our proposed DGGS | | | | |
|---|---|---|---|---|---|---|---|
| | P_{b} | # Cells | Mean | Std. Dev. | Min | Max | RMSE ↑ |
| 1 | I | 20 | 0.9418833 | 0.001814312 | 0.9335715 | 0.9999999 | 0.05814499 |
| 2 | IR⁴M_{g} | 5120 | 0.9417971 | 0.001722388 | 0.9335721 | 0.9432760 | 0.05822834 |
| 3 | IR³M_{g} | 1280 | 0.9416372 | 0.002150317 | 0.9335729 | 0.9441464 | 0.05840242 |
| 4 | IR²M_{g} | 320 | 0.9410083 | 0.003106135 | 0.9335745 | 0.9475639 | 0.05907345 |
| 5 | IR²Mₛ | 320 | 0.9397088 | 0.002637709 | 0.9335770 | 0.9465663 | 0.06034883 |
| 6 | IR³Mₛ | 1280 | 0.9395723 | 0.001886925 | 0.9335772 | 0.9440226 | 0.06045717 |
| 7 | IR⁴Mₛ | 5120 | 0.9394540 | 0.001539682 | 0.9335772 | 0.9432118 | 0.06056555 |
| 8 | PR²Mₛ | 960 | 0.9394006 | 0.001798091 | 0.9335654 | 0.9427323 | 0.06062607 |
| 9 | PR³Mₛ | 3840 | 0.9393582 | 0.001494640 | 0.9335654 | 0.9421862 | 0.06066020 |
| 10 | PR⁴Mₛ | 15360 | 0.9393230 | 0.001398864 | 0.9335654 | 0.9421495 | 0.06069315 |
| 11 | PRMₛ | 240 | 0.9392988 | 0.002400984 | 0.9335652 | 0.9459854 | 0.06074866 |
| 12 | IRM_{g} | 80 | 0.9391254 | 0.002424679 | 0.9335760 | 0.9602923 | 0.06092283 |
| 13 | IRMₛ | 80 | 0.9391254 | 0.002424679 | 0.9335760 | 0.9602923 | 0.06092283 |
| 14 | P | 60 | 0.9390448 | 0.001208531 | 0.9335648 | 0.9589797 | 0.06096719 |
| 15 | PR⁴M_{g} | 15360 | 0.9390248 | 0.001188993 | 0.9335649 | 0.9409994 | 0.06098676 |
| 16 | PR³M_{g} | 3840 | 0.9390071 | 0.001265904 | 0.9335650 | 0.9410292 | 0.06100604 |
| 17 | PR²M_{g} | 960 | 0.9389306 | 0.001516319 | 0.9335652 | 0.9415958 | 0.06108821 |
| 18 | I(RM_{g})² | 320 | 0.9389177 | 0.002636001 | 0.9335773 | 0.9475639 | 0.06113912 |
| 19 | I(RM_{g})³ | 1280 | 0.9388943 | 0.002642109 | 0.9335776 | 0.9441464 | 0.06116278 |
| 20 | I(RM_{g})⁴ | 5120 | 0.9388828 | 0.002640188 | 0.9335777 | 0.9432760 | 0.06117422 |
| 21 | PRM_{g} | 240 | 0.9386965 | 0.002047220 | 0.9335654 | 0.9450348 | 0.06133767 |
| 22 | D | 120 | 0.8737319 | 0.003002320 | 0.8663580 | 0.8827166 | 0.12630373 |
| 23 | DRMₛ | 480 | 0.8658798 | 0.008790841 | 0.8553493 | 0.8815749 | 0.13440782 |
| 24 | DR²Mₛ | 1920 | 0.8638314 | 0.009177870 | 0.8497816 | 0.8813500 | 0.13647730 |
| 25 | DR³Mₛ | 7680 | 0.8633066 | 0.009512230 | 0.8450996 | 0.8812937 | 0.13702374 |

TABLE 21
The statistics of the compactness of the cells in our proposed P_{b}. The compactness
is heavily correlated to the compactness of the original faces of the input
polyhdron. Thus, the icosahedron generally produces the most compact faces,
followed bythe pentakis dodecahedron. The disdyakis triacontahedron is a
distant last, with the least compact faces of any of them.

| | | # | Compactness (d_{C}) of our proposed DGGS | | | | |
|---|---|---|---|---|---|---|---|
| | P_{b} | Cells | Mean | Std. Dev. | Min | Max | RMSE ↑ |
| 1 | I | 20 | 0.9999999 | | 0.9999999 | 0.9999999 | 0.00000006 |
| 2 | P | 60 | 0.9589797 | | 0.9589797 | 0.9589797 | 0.04102030 |
| 3 | IRM_{g} | 80 | 0.9541176 | 0.004116452 | 0.9520594 | 0.9602923 | 0.04602066 |
| 4 | IRMₛ | 80 | 0.9541176 | 0.004116452 | 0.9520594 | 0.9602923 | 0.04602066 |
| 5 | IR²M_{g} | 320 | 0.9447871 | 0.003636927 | 0.9375231 | 0.9475639 | 0.05532507 |
| 6 | PRMₛ | 240 | 0.9443524 | 0.002962599 | 0.9399114 | 0.9459854 | 0.05570672 |
| 7 | PRM_{g} | 240 | 0.9437400 | 0.002439914 | 0.9400837 | 0.9450348 | 0.05629969 |
| 8 | IR²Mₛ | 320 | 0.9434710 | 0.002901626 | 0.9381775 | 0.9465663 | 0.05659877 |
| 9 | I(RM_{g})² | 320 | 0.9426708 | 0.003025837 | 0.9382672 | 0.9475639 | 0.05740406 |
| 10 | IR³M_{g} | 1280 | 0.9425553 | 0.002267740 | 0.9344409 | 0.9441464 | 0.05748872 |
| 11 | IR⁴M_{g} | 5120 | 0.9420038 | 0.001749697 | 0.9337658 | 0.9432760 | 0.05802244 |
| 12 | PR²Mₛ | 960 | 0.9406566 | 0.001881837 | 0.9351455 | 0.9427323 | 0.05937139 |
| 13 | IR³Mₛ | 1280 | 0.9404844 | 0.001925206 | 0.9347128 | 0.9440226 | 0.05954629 |
| 14 | PR²M_{g} | 960 | 0.9401846 | 0.001581977 | 0.9351111 | 0.9415958 | 0.05983503 |
| 15 | I(RM_{g})³ | 1280 | 0.9398045 | 0.002735372 | 0.9347408 | 0.9441464 | 0.06025660 |
| 16 | PR³Mₛ | 3840 | 0.9396622 | 0.001509109 | 0.9339556 | 0.9421862 | 0.06035641 |
| 17 | IR⁴Mₛ | 5120 | 0.9396592 | 0.001544650 | 0.9338475 | 0.9432118 | 0.06036049 |
| 18 | PR⁴Mₛ | 15360 | 0.9393913 | 0.001401808 | 0.9336583 | 0.9421495 | 0.06062482 |
| 19 | PR³M_{g} | 3840 | 0.9393107 | 0.001278013 | 0.9339322 | 0.9410292 | 0.06070258 |
| 20 | PR⁴M_{g} | 15360 | 0.9390931 | 0.001191588 | 0.9336503 | 0.9409994 | 0.06091850 |
| 21 | I(RM_{g})⁴ | 5120 | 0.9390876 | 0.002661476 | 0.9338549 | 0.9432760 | 0.06097028 |
| 22 | D | 120 | 0.8819678 | | 0.8819678 | 0.8819678 | 0.11803217 |
| 23 | DRMₛ | 480 | 0.8678753 | 0.010148252 | 0.8594994 | 0.8815520 | 0.13241666 |
| 24 | DR²Mₛ | 1920 | 0.8643113 | 0.009487952 | 0.8508555 | 0.8813500 | 0.13599931 |
| 25 | DR³Mₛ | 7680 | 0.8634143 | 0.009587359 | 0.8453704 | 0.8812937 | 0.13691648 |

### 7. Process Summaries

### 7.1. Process for Building a High-Resolution Base-Polyhedra

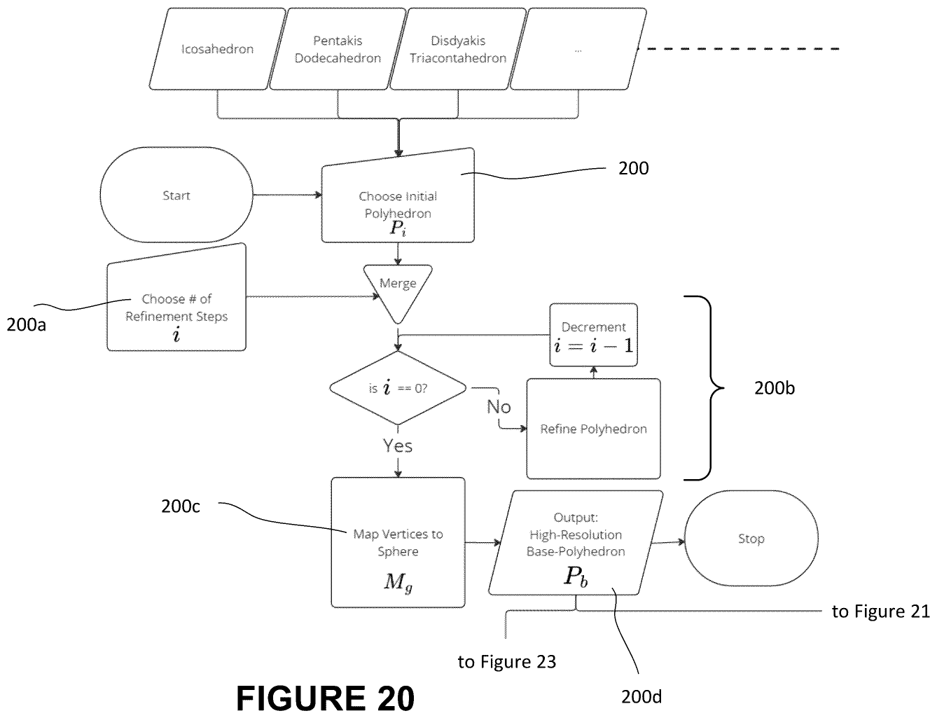

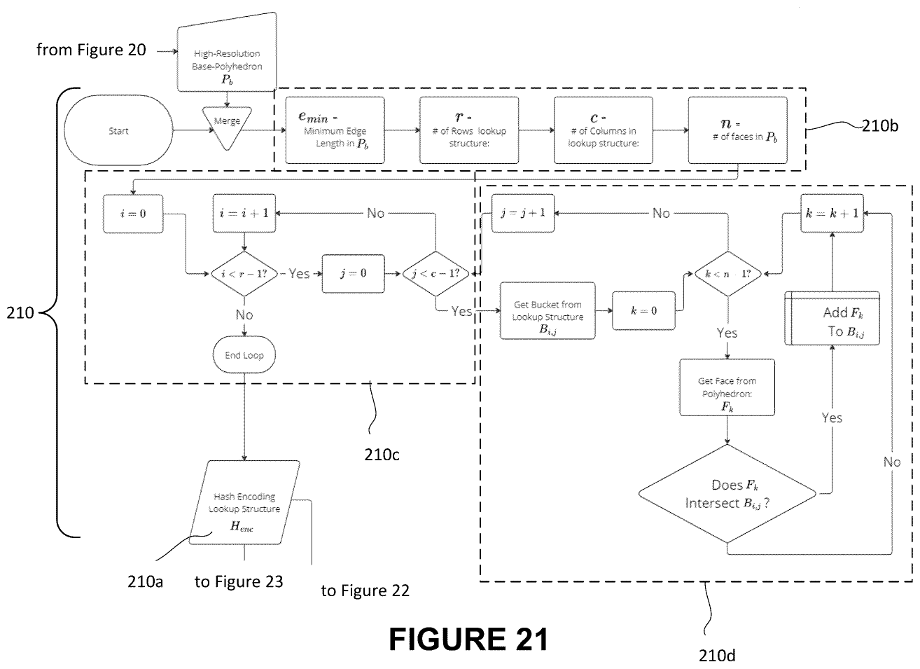

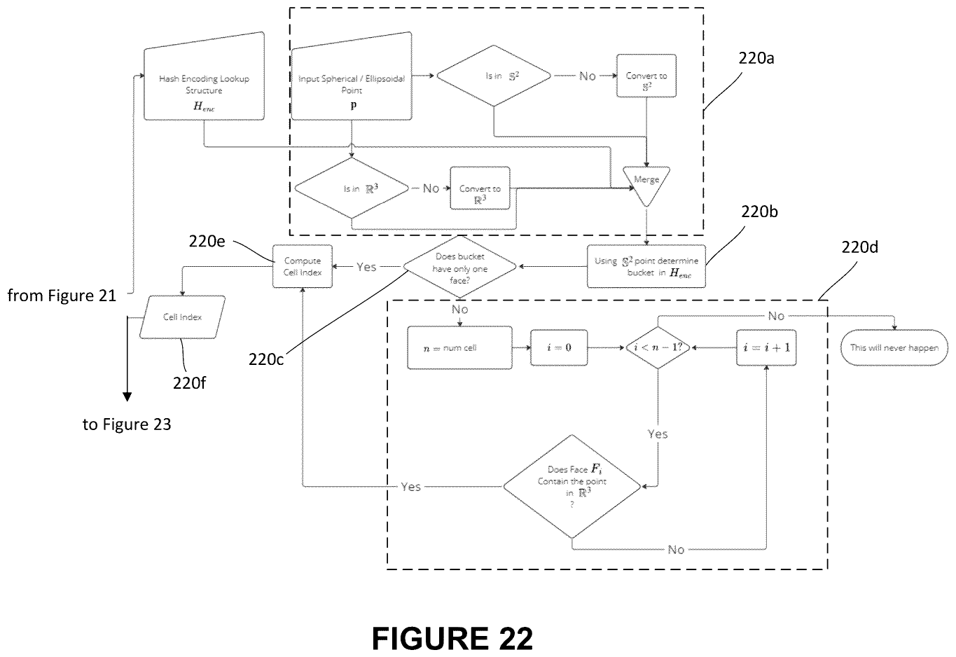

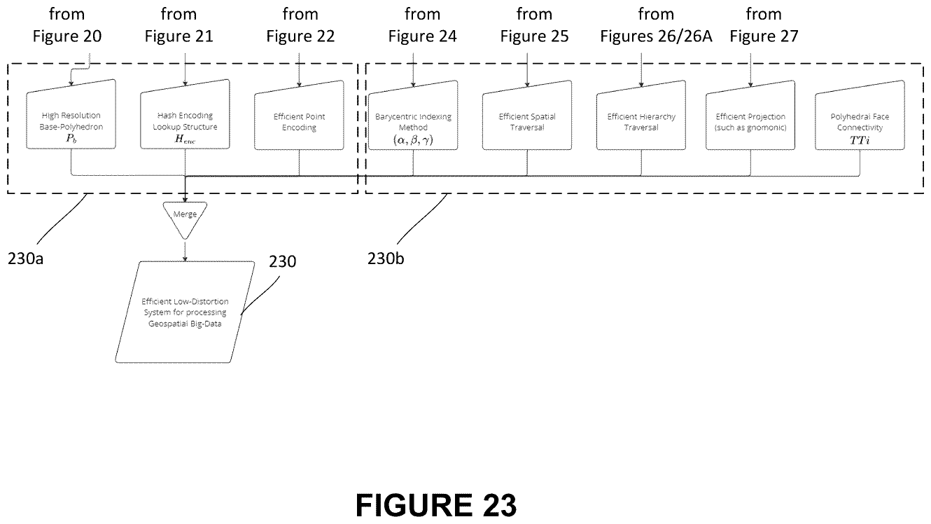

FIG. 20 shows a process for preparing a high-resolution base polyhedron that may be used for DGGS. As shown, an initial-polyhedron is chosen, for example a icosahedron, pentakis dodecahedron, disdyakis triacontrahedron, etc.

The number of refinement steps are chosen 200a and executed 200b. After refinement, the vertices are mapped to a sphere 200c using a mapping that preserves uniformity and that results in a highly-uniform, high-resolution base-polyhedron (HRBP) 200d. Planar faces may be triangles, quads, pentagons or hexagons.

### 7.2. Process for Building a Lookup Structure

FIG. 21 shows a process 210 for building a lookup structure 210a on the HRBP. This process includes defining and over-layering a grid having definable coordinates on the HRBP as shown in FIG. 6. Initially, a grid is defined 210b by defining each of a minimum grid edge length, the number of rows and columns in the lookup structure and the resulting number of faces defined by the foregoing. As described above, the elements of the overlayed-grid are referred to as buckets.

As such, each bucket can be considered as a grid elements having grid coordinates (e.g. latitude and longitude) that overlay the planar faces of the HRBP. As described above, and depending on the size of each bucket relative to each planar face, buckets may fully contain a planar face, be fully within a planar face, overlap a face boundary or contain a planar face vertex of multiple planar faces as shown in FIG. 6.

After defining the buckets, iterative processes (boxes 210c, 210d) are executed to determine the location of a bucket relative to a face. Process 210c iterates over all of the buckets in the lookup grid and process 210d iterates over every face of the HRBP and determines if the face contains, is contained by, or intersects each bucket.

In essence, the processes 210c, 210d define a method of determining which planar faces of the HRBP, a point may be associated with when a geospatial point of interest is contained within the bucket coordinates.

### 7.3. Process for Efficient Point Encoding

FIG. 22 shows processes for efficient point encoding using an efficient hash encoding lookup structure (for example the Point to BaseCell operation as described above).

As shown, grid coordinates are typically either lat/long or x,y,z coordinates.

Initially, for a given input of a point, P, the system checks and/or converts coordinates of the point to both desired coordinate system (box 220a).

Thereafter, the system determines which bucket a point is associated with (box 220b). That is, based on the lat/long coordinates of the point, the associated bucket can be efficiently determined based on the grid.

The system then checks to determine if that bucket has only one associated face. That is, as noted above, a bucket may be associated with a single or multiple faces and, thus, it is desired to associate the bucket with a single face according to various rules.

Initially, the system checks if the bucket has only one face (box 220c). If yes, the point is associated with that face.

If no, an iterative rule-based process 220d is followed to associate the point with one face based on the potential that a bucket may overlap a vertex and could thus be associated with any one of n planar faces (i.e. the bucket overlays a vertex of the base-polyhedron). Process 220d, based on rules, assigns the point to one of the faces that may be within a bucket. For example, in the event of a bucket over layering a vertex having six adjoining faces, one of six faces is chosen. In other generalized instances, any one of n faces may be chosen where n is the valence of the base-polyhedron.

Ultimately, once a point is associated with a face, a cell index is computed (boxes 220e, 220f).

### 7.4. Processes for Building an Efficient Low-Distortion System for Processing Geospatial Data

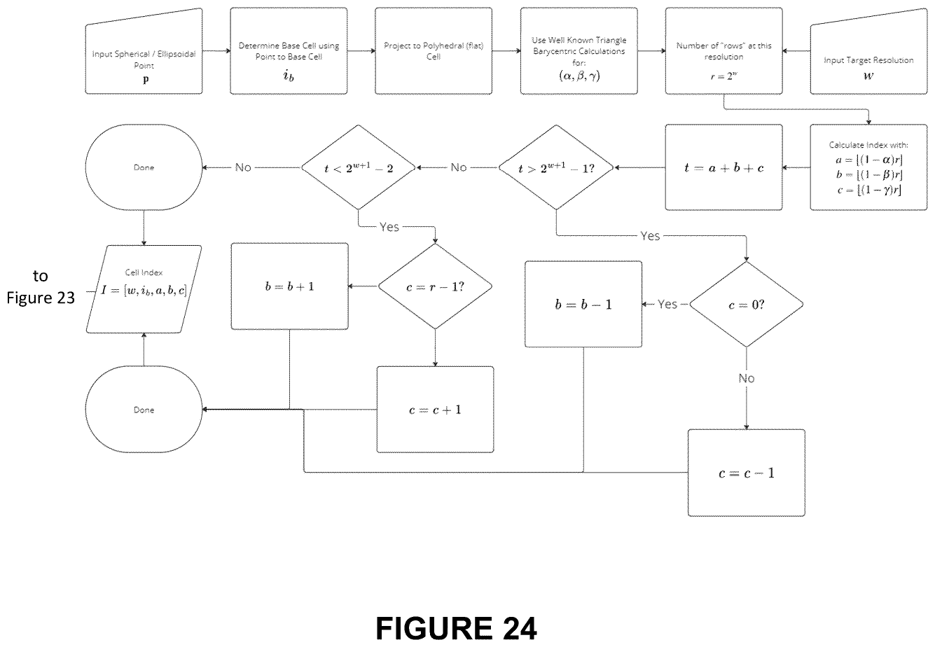

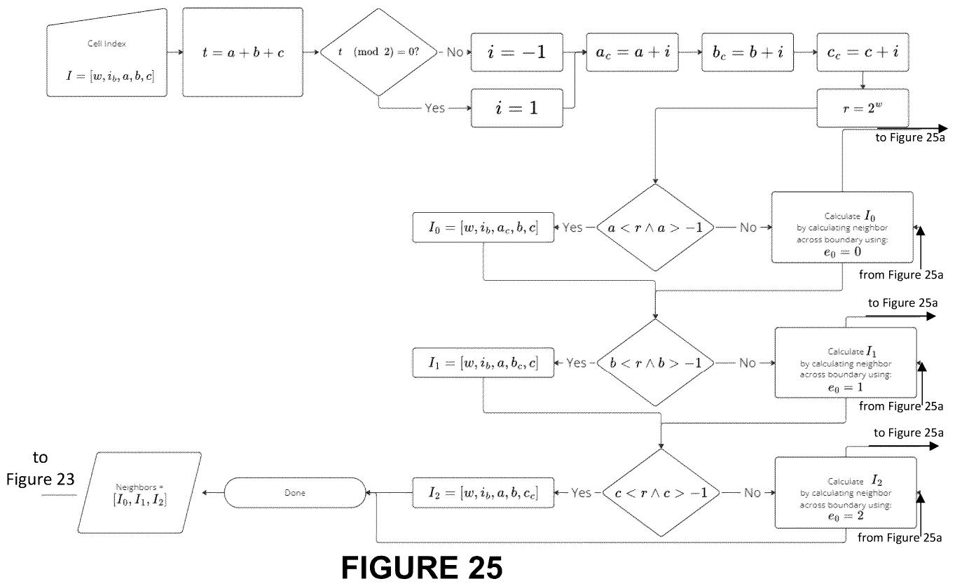

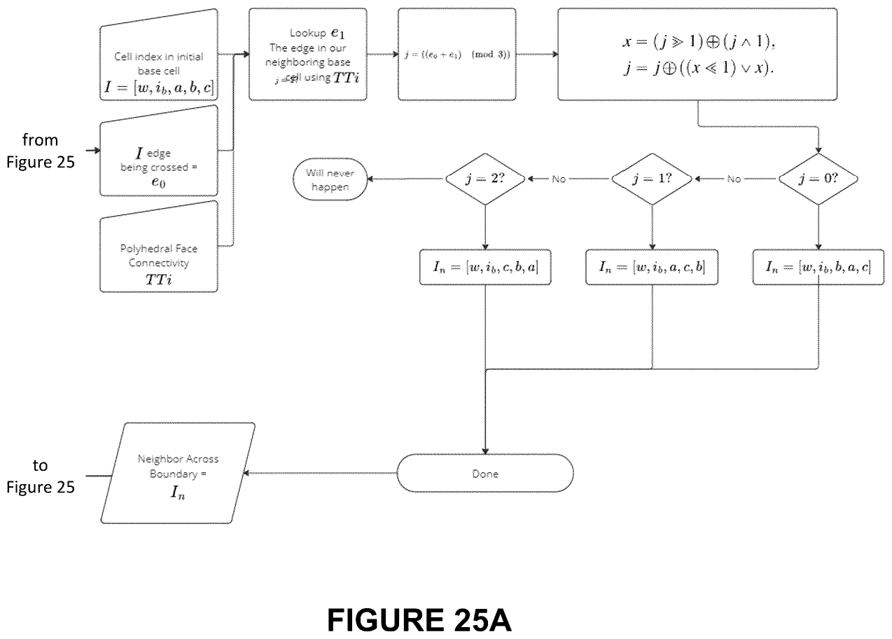

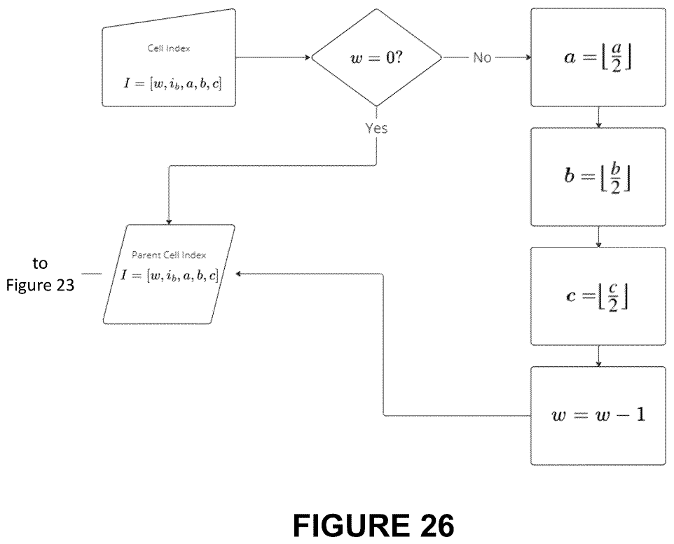

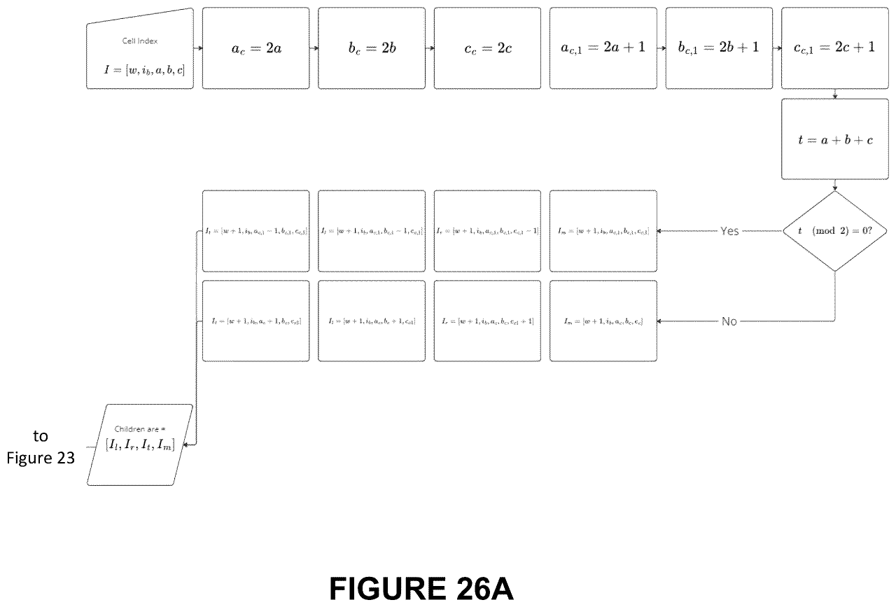

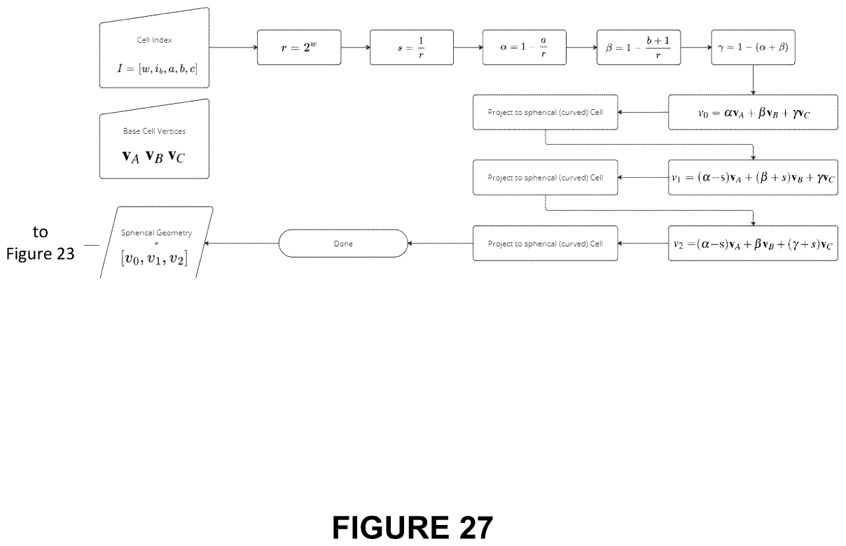

FIG. 23 shows processes for building an efficient low-distortion system for processing geospatial data 230.

As shown, at a first level, inputs (box 230a) including a HRBP, a hash-encoding lookup structure and efficient point encoding processes are merged to create the efficient low-distortion system for processing geospatial data 230. The system, via the combination of the HRBP, the processes for defining the lookup structure, and the processes for encoding a point (e.g. a geospatial data Point) provide an efficient system that enables applications for rapid identification and output of geospatial data associated within a DGGS.

### 7.5. Additional Processes

As shown in FIGS. 24-27, the system 230 can be refined by additional processes (box 230b) as described below including processes for barycentric indexing (FIG. 24), efficient spatial traversal (FIG. 25), parent (FIG. 26) and child (FIG. 26A) calculations and efficient projection (FIG. 27).

FIG. 24 shows an iterative process to calculate the index for a given cell based on a given point and the base cell that contains the given point. The process includes using the given point (p), the resolution (w) and the base cell (i_b) as input and a projection system to project to the flat face. The process then calculates alpha, beta and gamma using known techniques. The number of rows (r) can be calculated using a simple and efficient formula and a, b, and c can be calculated using simple and efficient formulas. Verification steps can be completed to make sure an invalid index has been calculated. This is the “computing the cell index” (220f) process as described above.

FIGS. 25 and 25A show processes for neighbor (FIG. 25) and neighbor across boundary (FIG. 25A) calculations as input to the efficient mesh-based DGGS process (FIG. 23).

FIG. 25 is calculating the indices of the neighbor cells ([I_0, I_1, I_3]) from a given input cell (1). When calculating neighbor cells some of the neighbors may cross over into a neighboring base cell and some will be in the same base cell as 1. In the easy case, all will be in the same base cell. There are two cases, one is when the cell is oriented in the same way as the base cell and one when the cell is oriented in the opposite direction. Adding up a, b, and c and checking to see if the sum is even determines which case. In a first case, one is subtracted from each of a, b, and c, and in a second case one is added.

Thereafter, the system checks to see if a, b, and c are too large or too small. If they are too large or too small, then a different method is used to calculate the index of the cell across the boundary. From this, for all of a, b, and c, there are three indices representing the neighbor cells.

FIG. 25A is a process by which the cell index across the boundary is calculated. The process includes looking up which edge is being crossed (for both this base cell and the neighboring one). Once completed, a series of bitwise operations (bit shifts, exclusive ors, exclusive ands etc.) are conducted as explained above. This determines which of a, b, or c stays the same. The other two swap positions.

FIGS. 26 and 26A show processes for parent and child calculations as input to the efficient mesh-based DGGS process (FIG. 23).

FIG. 26 shows a process to calculate the parent cell index from a given index including the step of dividing by 2 and taking the floor and reducing the value of w by 1. FIG. 26A shows a process to calculate the children cells from a given cell. There are always more children, so no check is needed. However, there are two rules, which depend on the orientation of the cell relative to its base cell. The process includes multiplying each index by two, and then adding 1. This provides a middle child cell after w is decremented by one. From here, if oriented the same as the base cell, one is subtracted from each coordinate and if oriented differently from the base cell, one is added to each coordinate giving three more children cells. Together with FIG. 26, this describes spatial traversal.

FIG. 27 illustrates a process to calculate the spherical geometry from a given cell. The process includes calculating the positions of the three vertices using barycentric coordinates as described above.

### 8. References

[1] M. F. Goodchild, “Reimagining the history of GIS,” Annals of GIS, vol. 24, no. 1, pp. 1-8, 2018.
[2] T. Alderson, M. Purss, D. Xiaoping, A. Mahdavi-Amiriand, and F. Samavati, Manual of Digital Earth, Chapter on Digital Earth Platforms https://link.springer.com/book/10.1007/978-981-32-9915-3?, 11 2019, pp. 25-54.
[3]E. Veach, “S2 geometry,” https://s2geometry.io/, (accessed on 13 Aug. 2023).
[4] Uber, “H3: Uber's hexagonal hierarchical spatial index,” https://www.uber.com/en-CA/blog/h3/, (accessed on 13 Aug. 2023).
[5]E. Harrison, A. Mahdavi-Amiri, and F. Samavati, “Optimization of inverse snyder polyhedral projection,” in Cyberworlds (CW), 2011 International Conference on. IEEE Computer Society, Oct. 4-6 2011, pp. 136-143.
[6], “Analysis of inverse snyder optimizations,” in Transactions on Computational Science XVI, ser. Lecture Notes in Computer Science, M. Gavrilova and C. Tan, Eds. Springer Berlin Heidelberg, 2012, vol. 7380, pp. 134-148.
[7] M. Nießner, M. Zollhofer, S. Izadi, and M. Stamminger, “Real-time 3d recon-”struction at scale using voxel hashing,” ACM Transactions on Graphics (ToG), vol. 32, no. 6, pp. 1-11, 2013.
[8] T. Muller, A. Evans, C. Schied, and A. Keller, “Instant neural graphics primitives” with a multiresolution hash encoding,” ACM Transactions on Graphics (ToG), vol. 41, no. 4, pp. 1-15,2022.
[9]Q. Wu, D. Bauer, M. J. Doyle, and K.-L. Ma, “Interactive volume visualization via multi-resolution hash encoding based neural representation,” IEEE Transactions on Visualization and Computer Graphics, 2023.
[10] A. Mahdavi-Amiri, T. Alderson, and F. Samavati, “A survey of digital earth,” Computers & Graphics, vol. 53, pp. 95-117, 2015.
[11] A. Mahdavi-Amiri and F. Samavati, “Atlas of connectivity maps,” Computers & Graphics, vol. 39, pp. 1-11, 2014.
[12] G. Dutton, “Part 4: mathematical, algorithmic and data structure issues: geodesic modelling of planetary relief,” Cartographica: The International Journal for Geographic Information and Geovisualization, vol. 21, no. 2-3, pp. 188-207, 1984.
[13] J. Nievergelt, “7+ or −2 criteria for assessing and comparing spatial data structures,” NORTH CAROLINA UNIV AT CHAPEL HILL DEPT OF COMPUTER SCIENCE, Tech. Rep., 1989.
[14] H. Samet, The design and analysis of spatial data structures. Addison-wesley Reading, MA, 1990, vol. 85.
[15] G. Fekete and L. A. Treinish, “Sphere quadtrees: a new data structure to support the visualization of spherically distributed data,” in Extracting Meaning from Complex Data: Processing, Display, Interaction, E. J. Farrell, Ed., vol. 1259. SPIE, 1990, pp. 242-253. [Online]. Available: https://doi.org/10.1117/12.19991
[16] M. F. Goodchild and Y. Shiren, “A hierarchical spatial data structure for global geographic information systems,” CVGIP: Graphical Models and Image Processing, vol. 54, no. 1, pp. 31-44,1992.
[17] D. White, J. A. Kimerling, and S. W. Overton, “Cartographic and geometric components of a global sampling design for environmental monitoring,” Cartography and geographic information systems, vol. 19, no. 1, pp. 5-22, 1992.
[18] K. Sahr and D. White, “Discrete global grid systems,” Computing Science and Statistics, pp. 269-278, 1998.
[19] S. Huang, R. Shibasaki, M. Kasuya, and M. Takagi, “Comparative study on spherical tessellation schemes for global gis,” Geocarto International, vol. 13, no. 1, pp. 3-14, 1998.
[20] D. White, A. Kimerling, K. Sahr, and L. Song, “Comparing area and shape distortion on polyhedral-based recursive partitions of the sphere.” International Journal of Geographical Information Science, vol. 12, pp. 805-827, 12 1998.
[21] J. Kimerling, K. Sahr, D. White, and L. Song, “Comparing geometrical properties of global grids,” Cartography and Geographic Information Science, vol. 26, no. 4, pp. 271-288, 2013.
[22] R. Gibb, “The rhealpix discrete global grid system,” E&ES, vol. 34, no. 1, p. 012012, 2016.
[23] J. A. Thompson, M. J. Brodzik, K. A. Silverstein, M. A. Hurley, and N. L. Carlson, “Ease-dggs: a hybrid discrete global grid system for earth sciences,” Big Earth Data, vol. 6, no. 3, pp. 340-357, 2022.
[24] R. Crittenden and N. Turok, “Exactly azimuthal pixelizations of the sky,” arXiv 0712.0157, July 1998.
[25] J. S. et al., “Bing maps tile system,” https://learn.microsoft.com/en-us/bingmaps/articles/bing-maps-tile-system, (accessed on 23 Oct. 2023).
[26] Google-Maps-Contributors, “Google maps 2d tiles overview,” https://developers. google.com/maps/documentation/tile/2d-tiles-overview, (accessed on 23 Oct. 2023).
[27] OSM-Wiki-Contributors, “Open street map quad tiles,” https://wiki. openstreetmap.org/wiki/QuadTiles, (accessed on 23 Oct. 2023).
[28] M. Purss, R. Gibb, F. Samavati, P. Peterson, J. Andrew Rogers, J. Ben, and C. Dow, OGC Discrete Global Grid System (DGGS) Core Standard, 1st ed., Open Geospatial Consortium, August 2017.
[29] J. Hall, L. Wecker, B. Ulmer, and F. Samavati, “Disdyakis triacontahedron dggs,” ISPRS International Journal of Geo-Information, vol. 9, no. 5, p. 315, May 2020. [Online]. Available: http://dx.doi.org/10.3390/ijgi9050315
[30] H. P. Bailey, “Two grid systems that divide the entire surface of the earth into quadrilaterals of equal area,” Eos, Transactions American Geophysical Union, vol. 37, no. 5, pp. 628-635, 1956.
[31] M. Paul, “On computation of equal area blocks,” Bulletin Geod'esique (1946-'1975), vol. 107, no. 1, pp. 73-84,1973.
[32] J. Thuburn, “A pv-based shallow-water model on a hexagonal-icosahedral grid,” Monthly Weather Review, vol. 125, no. 9, pp. 2328-2347,1997.
[33] A. S. Szalay, J. Gray, G. Fekete, P. Z. Kunszt, P. Kukol, and A. Thakar, “Indexing the sphere with the hierarchical triangular mesh,” arXiv preprint cs/0701164, 2007.
[34] F. E. Wickman, E. Elvers, and K. Edvarson, “A system of domains for global sampling problems,” Geografiska Annaler: Series A, Physical Geography, vol. 56, no. 3-4, pp. 201-212, 1974.
[35] L. Song, A. J. Kimerling, K. Sahr et al., “Developing an equal area global grid by small circle subdivision,” National Center for Geographic Information & Analysis, Santa Barbara, CA, USA, 2002.
[36] K. F. Gauss, “General investigations of curved surfaces of 1827 and 1825,” Nature, vol. 66, pp. 316-317, 2012.
[37] R. Mukundan, “Mesh tessellation,” in 3D Mesh Processing and Character Animation: With Examples Using OpenGL, OpenMesh and Assimp. Springer, 2022, pp. 91-128.
[38] J. A. Kimerling, K. Sahr, D. White, and L. Song, “Comparing geometrical properties of global grids,” Cartography and Geographic Information Science, vol. 26, no. 4, pp. 271-288, 1999.
[39] H. Alborzi and H. Samet, “Augmenting sand with a spherical data model,” in First International Conference on Discrete Global Grids. Santa Barbara, California, March, March 2000, pp. 26-28.
[40] A. M. Amiri, F. Bhojani, and F. Samavati, “One-to-two digital earth,” in Advances in Visual Computing, G. Bebis, R. Boyle, B. Parvin, D. Koracin, B. Li, F. Porikli, V. Zordan, J. Klosowski, S. Coquillart, X. Luo, M. Chen, and D. Gotz, Eds. Berlin, Heidelberg: Springer Berlin Heidelberg, 2013, pp. 681-692.
[41] D. White, “Global grids from recursive diamond subdivisions of the surface of an octahedron or icosahedron,” Environmental Monitoring and Assessment, vol. 64, pp. 93-103, 09 2000.
[42] A. Vince, “Indexing the aperture 3 hexagonal discrete global grid,” Journal of Visual Communication and Image Representation, vol. 17, no. 6, pp. 1227-1236, 2006.
[43] J. Ben, X. Tong, and R. Chen, “A spatial indexing method for the hexagon discrete global grid system,” in 2010 18th international conference on geoinformatics. IEEE, 2010, pp. 1-5.
[44] J. R. Baumgardner and P. O. Frederickson, “Icosahedral discretization of the two-sphere,” SIAM Journal on Numerical Analysis, vol. 22, no. 6, pp. 1107-1115, 1985. [Online]. Available: http://www.jstor.org/stable/2157540
[45] J. Ben, X.-c. Tong, Y.-s. Zhang, and H. Zhang, “Discrete global grid systems: Generating algorithm and software model,” in Geoinformatics 2006: Geospatial Information Technology, vol. 6421. International Society for Optics and Photonics, 2006, p. 64210J.
[46] X. Tong, J. Ben, and Y. Wang, “A new effective hexagonal discrete global grid system: Hexagonal quad balanced structure,” in 2010 18th International Conference on Geoinformatics. IEEE, 2010, pp. 1-6.
[47] B. Lin, L. Zhou, D. Xu, A.-X. Zhu, and G. Lu, “A discrete global grid system for earth system modeling,” International Journal of Geographical Information Science, vol. 32, no. 4, pp. 711-737, 2018.
[48] K. M. Gorski, E. Hivon, A. J. Banday, B. D. Wandelt, F. K. Hansen, M. Reinecke, and M. Bartelmann, “Healpix: A framework for high-resolution discretization and fast analysis of data distributed on the sphere,” The Astrophysical Journal, vol. 622, no. 2, p. 759, 2005.
[49] T. Bernardin, E. Cowgill, O. Kreylos, C. Bowles, P. Gold, B. Hamann, and L. Kellogg, “Crusta: A new virtual globe for real-time visualization of sub-meter digital topography at planetary scales,” Computers & Geosciences, vol. 37, no. 1, pp. 75-85, 2011.
[50] K. Sahr, “Hexagonal discrete global grid systems for geospatial computing,” Archiwum Fotogrametrii, Kartografii i Teledetekcji, vol. 22, pp. 363-376, 2011.
[51] C. Robertson, C. Chaudhuri, M. Hojati, and S. A. Roberts, “An integrated environmental analytics system (ideas) based on a dggs,” ISPRS Journal of Photogrammetry and Remote Sensing, vol. 162, pp. 214-228, 2020.
[52] I. PYXIS Innovation, “How pyxis works,” http://www.pyxisinnovation.com/pyxwiki/index.php?title=How PYXIS Works, September 2014, accessed: 202004-01.
[53] G. H. Dutton, A hierarchical coordinate system for geoprocessing and cartography. Springer, 01 1999, vol. 79.
[54] C. Bohm, M. Perdacher, and C. Plant, “A novel hilbert curve for cache-locality“preserving loops,” IEEE Transactions on Big Data, vol. 7, no. 2, pp. 241-254, 2018.
[55] A. Bradley, “Equal-area projection on the icosahedron,” Geographical Review, vol. 36, no. 1, pp. 101-104, 1946.
[56] J. P. Snyder, “An equal-area map projection for polyhedral globes,” Cartographica: The International Journal for Geographic Information and Geovisualization, vol. 29, no. 1, pp. 10-21,1992.
[57] ______, Flattening the Earth: Two Thousand Years of Map Projections. University of Chicago Press, 1997.
[58] D. van Leeuwen and D. Strebe, “A” slice-and-dice” approach to area equivalence in polyhedral map projections,” Cartography and Geographic Information Science, vol. 33, no. 4, pp. 269-286, 2006.
[59] D. Ros,ca and G. Plonka, “Uniform spherical grids via equal area projection from the cube to the sphere,” Journal of Computational and Applied Mathematics, vol. 236, no. 6, pp. 1033-1041, 2011.
[60] D. Ros,ca and G. Plonka, “An area preserving projection from the regular octahedron to the sphere,” Results in Mathematics, vol. 62, no. 3, pp. 429-444, Dec 2012.
[61] M. Hojati and C. Robertson, “Integrating cellular automata and discrete global grid systems: a case study into wildfire modelling,” AGILE: G/Science Series, vol. 1, pp. 1-23, 2020.
[62] M. Teschner, B. Heidelberger, M. Muller, D. Pomerantes, and M. H. Gross, “Op-”timized spatial hashing for collision detection of deformable objects.” in Vmv, vol. 3, 2003, pp. 47-54.
[63] Wikipedia contributors, “Line plane intersection,” 2023, [Online; accessed 27 May 2023]. [Online]. Available: https://en.wikipedia.org/wiki/Line % E2% 80%93plane intersection
[64] D. Stutz, “Learning shape completion from bounding boxes with cad shape priors,” 2017.
[65] B. Smits, P. Shirley, and M. M. Stark, “Direct ray tracing of displacement mapped triangles,” in Rendering Techniques 2000: Proceedings of the Eurographics Workshop in Brno, Czech Republic, Jun. 26-28, 2000 11. Springer, 2000, pp. 307-318.
[66] C. Ericson, Real-time collision detection. Crc Press, 2004.
[67]E. Veach, “S2 geometry cell hierarchy,” https://s2geometry.io/devguide/s2cell_hierarchy, (accessed on 21 Feb. 2024).
[68] ______, “S2 geometry,” https://s2geometry.io/resources/s2cell statistics, (accessed on 13 Aug. 2023).
[69] Uber, “H3: Cell statistics,” https://h3geo.org/docs/core-library/overview/, (accessed on 21 Feb. 2024).
[70] ______, “H3: Cell statistics,” https://h3geo.org/docs/core-library/restable, (accessed on 13 Aug. 2023).
______, “H3: Cell distortiohn,” https://h3geo.org/docs/core-library/restable #appendix-methodology, (accessed on 21 Feb. 2024).
[72] M. Leitner-Ankerl, “nanobench documentation,” 2023, (accessed on 28 Aug. 2023).
[73] H. Wickham, M. Averick, J. Bryan, W. Chang, L. D. McGowan, R. Franc,ois, G. Grolemund, A. Hayes, L. Henry, J. Hester, M. Kuhn, T. L. Pedersen, E. Miller, S. M. Bache, K. Muller, J. Ooms, D. Robinson, D. P. Seidel, V. Spinu, K. Taka-“hashi, D. Vaughan, C. Wilke, K. Woo, and H. Yutani, “Welcome to the tidyverse,” Journal of Open Source Software, vol. 4, no. 43, p. 1686, 2019.
[74] I. Patil, “Visualizations with statistical details: The ‘ggstatsplot’ approach,” Journal of Open Source Software, vol. 6, no. 61, p. 3167, 2021. [Online]. Available: https://doi.org/10.21105/joss.03167

### 9. Appendices

### 9.1. Memory Usage

DGGS are comprised of the faces of the base polyhedron, cached information for efficient operations, and the hash-encoding lookup structure. The mesh's geometry is stored as a single array of vertices, where every vertex contains three double-floating point quantities. Given n faces in the base polyhedron, this results in n°8°3 for the geometry of the base polyhedron.

In addition, another array of per-face pre-calculated information is stored that aids in the calculation of certain operations:
Projection quantities: A vector representing the normal of the triangle (pointing away from the origin) and the scalar dot product between the normal and the first vertex of the face. These are used when projecting or inverse-projecting between the spherical and planar counterparts.
Point in cell quantities: 3 vectors representing the normals of the planes formed by each edge, pointing inwards towards the triangle. These are used for determining if a point is contained within the triangle when more than one candidate face is returned from the hash-encoding lookup structure.
Information for calculating barycentric coordinates: Three vectors and four scalar quantities. These are used when calculating the barycentric coordinates of an incoming point and are quantities that depend only on the triangle and thus can be precalculated to improve the speed of this operation.

In total, n*208 bytes of information are stored to improve the performance of various operations.

To allow for the neighbor operation to be calculated when neighbors cross the edges of a face of the base polyhedron, connectivity between each face is stored. These are stored in a format that maps each face i and each edge j∈[0,2] tuple (i,j) to face k that is a neighbor of i across edge j. In addition, a second lookup is provided that maps each (i,j) to m where m∈[0,2] is the edge number for face k, which shares an edge with face i. Thus, the neighbor of face i across edge j is k, and the neighbor face k across edge m is i.

The hash encoding lookup structure has the largest memory footprint in the DGGS. Recall that a heuristic is used to choose how many times one should partition the latitude and longitude ranges for the partitioning structure. The bucket edge size is configurable, representing a tradeoff between performance and memory usage. However, all experimental evaluations have been done with a value of 0.1 In table 15, the number of partitions are reported and used with this factor for the latitude (denoted a) and longitude (denoted b).

The hash encoding information is stored in a contiguous array to ensure to ensure values are in the CPU cache for its operations. This array is calculated in a two-pass pre-processing step, which uses two different representations, and only the second representation is maintained. In the first pass, one calculates which base polyhedra are candidates for each bucket in the lookup structure and store this in a dynamically allocated structure. The maximum number of candidate faces that any bucket contains, denoted e are then calculated. In a second pass, this structure is converted to a single contiguous array of 16-bit unsigned integers (u16). The array contains enough space for a*b*(e+1) values of type u16. Each bucket has e+1 values, the first in the sequence representing the number of candidate faces and each of the rest representing the index of a candidate face. Thus, the number of bytes used by the overall structure is a*b*(e+1)*2 for the array and 24 for storing each of a, b, and e.

Table 14 reports the memory usage for the recommended base polyhedra.

1. A method of generating a high-resolution spherical geometry model comprising the steps of:
from an initial polyhedra having multiple planar base faces:
a) refine the initial polyhedra to form a refined base polyhedra wherein each planar base face is refined to include a plurality of child faces having child face vertices;
b) map the child face vertices from step a) to a sphere to form a spherical high-resolution base-polyhedron model characterized as highly-uniform wherein all child faces are the same shape and size.

2. The method as in claim 1 wherein the planar base faces are any one of a triangle, quad, pentagon or hexagon.

3. The method as in claim 1 wherein the base faces are triangles.

4. The method as in claim 1 wherein the child faces have low-angular distortion.

5. The method as in claim 4 wherein angular distortion is less than 0.09, and more preferably is less than 0.01.

6. The method as in claim 1 wherein step a) includes refining each planar base face to n child faces having child face vertices.

7. The method as in claim 1 wherein each planar base face is a triangle and step a) includes refining each base face to n² child faces having child face vertices.

8. The method as in claim 1 further comprising the step of repeating step a) one or more times prior to step b).

9. The method as in claim 1 wherein step b) is a uniformity-preserving projection and includes mapping vertices of the refined base polyhedra to a sphere and connecting vertices with geodesic edges.

10. The method as in claim 1 where the high-resolution base polyhedra has geodesic edges.

11. The method as in claim 10 where the geodesic edges are great circle arcs in spherical space and straight lines in polyhedral space.

12. The method as in claim 1 where the high-resolution initial polyhedra is any one of an octahedron, icosahedron, pentakis dodecahedron or disdyakis triacontrahedron.

13. The method as in claim 1 wherein step b) is a uniformity preserving projection configured to map the child face vertices from step a) to a sphere.

14. The method as in claim 13 wherein the uniformity preserving projection is an equal area projection work.

15. The method as in claim 13 wherein the uniformity preserving projection is a slice-and-dice equal area projection.

16. The method as in claim 1 wherein the refined polyhedron has a maximum area/minimum area ratio less than 1.9.

17. The method as in claim 1 wherein the refined polyhedron has a maximum area/minimum area ratio less than 1.5 and preferably less than 1.25.

18. A method of creating a lookup structure on a base polyhedron model having a plurality of planar faces having planar face edges and face vertexes to produce a lookup structure, comprising the steps of:
a) defining a grid having a plurality of grid elements where the grid defines an array of buckets;
b) overlaying the grid from step a) on the base polyhedron model wherein each bucket is overlaid on the planar faces such that each bucket:
i) is fully contained within a planar face;
ii) overlaps a planar face edge;
iii) overlaps a face vertex; or
iv) fully contains a planar face;
to produce an encoded lookup structure having lookup cells.

19. The method as in claim 18 wherein the planar faces are any one of a triangle, quad, pentagon or hexagon.

20. The method as in claim 18 wherein the planar faces are triangles.

21. The method as in claim 18 wherein the grid elements are defined by a grid having a minimum grid edge length and a number of rows and columns in the lookup structure.

22. The method as in claim 21 wherein each row of the grid is defined in latitude coordinates and each column of the grid is defined in longitude coordinates.

23. The method as in claim 18 further comprising the steps of determining if a bucket is contained within a planar face, or intersects a planar face and, if yes, associating a bucket with a planar face.

24. The method as in claim 18 further comprising the step of determining if a bucket contains a planar face.

25. The method as in claim 18 wherein step a) includes calculating a minimum planar face edge length.

26. A method of encoding a geospatial point to a lookup structure having a plurality of buckets overlaid on a base polyhedron model, comprising the steps of:
i) for a given geospatial point having point coordinates:
(1) determining which bucket of the lookup structure the geospatial point is associated with;
(2) determining if the bucket has only one face;
(a) if yes, computing a cell index for the geospatial point;
(b) if no, applying a rule to determine which face within the bucket contains the geospatial point, and, thereafter assigning a cell index for the geospatial point.

27. The method as in claim 26 wherein step i) for a given geospatial point having point coordinates includes converting the point coordinates to R³ and S2 geometry coordinates.

28. The method as in claim 27 wherein in step (2)(b), R³ geometry coordinates are utilized to determine which face within the bucket contains the geospatial point.

29. An efficient low-distortion system for processing geospatial data comprising:
a spherical high-resolution base-polyhedron model (HRBP) characterized as highly-uniform wherein all children are planar faces having a uniform shape and size;
the HRBP having an encoded look-up structure, having a bucket wherein each bucket is overlaid on the planar faces such that each bucket:
i) is fully contained within a planar face;
ii) overlaps a planar face edge;
iii) overlaps a planar vertex; or
iv) fully contains a planar face; and,
one or more geospatial points encoded to the lookup structure wherein each point is associated with a single planar face of a bucket.

30. The system as in claim 29 wherein the planar faces are any one of a triangle, quad, pentagon or hexagon.

31. The system as in claim 29 wherein the planar faces are triangles.

32. The system as in claim 29 wherein the encoded look-up structure has grid elements overlaid on the HRBP defining an array of buckets.

33. The system as in claim 29 further comprising an indexing system.

34. The system as in claim 33, wherein the indexing system is a barycentric index and wherein the barycentric index is derived from a barycentric index method including step of, for a given cell based on a given geospatial point, projecting the geospatial point to the face.

35. The system as in claim 29, further comprising a neighbor cell index, wherein the neighbor cell index is derived from a neighbor cell index method including the step of determining an orientation of a cell as aligned or not-aligned with a base face.

36. The system as in claim 29 further comprising a parent cell index, wherein the parent cell index is derived from a parent cell index method.

37. The system as in claim 36 further comprising a child cell index, wherein the child cell index is derived from a child cell index method.

38. The system as in claim 29 further comprising a spherical geometry for a given cell.
